(19) United States
(12) Patent Application Publication
(10) Pub. No.: US 2009/0004615 A1
(43) Pub. Date: Jan. 1, 2009

(54) Roller hearth calcining furnace and method of use

(76) Inventor: Robert G. Graham, Presque Isle, MI (US)

Correspondence Address: MCKELLAR IP LAW, PLLC, 784 SOUTH POSEYVILLE ROAD, MIDLAND, MI, 48640, US

(21) Appl. No.: 12/215,161

(22) Filed: Jun. 25, 2008

Related U.S. Application Data
(60) Provisional application No. 60/937,319, filed on Jun. 27, 2007.

(51) Int. Cl. F27B 9/00

(52) U.S. Cl. 432/121

(57) ABSTRACT

A roller hearth calcining furnace that uses a movable fluid bed that is transported through plural heating modules, each heating module independently heated using an indirect heating system. The indirect heating system includes an oxidizer, an all-ceramic, indirect, air-to-air heat exchanger, and one or more metal heat exchangers. The oxidizer can be fired with oil, coal, natural gas or other means, is impervious to attack from dirty fuels, and produces clean hot air for productive use. The movable fluid bed includes a permeable silicon carbide ceramic plate that resides within, and is supported by, a sagger or tray. The sagger is transported on rollers through the plural heating modules, and thus different temperature zones within a furnace as required by the temperature profile of the material being calcined.

### BACKGROUND OF THE INVENTION

Calcining is the process by which chemically bound water is driven off a substance by heating the substance to a critical temperature. This process may consist of kiln drying for relatively inexpensive materials like cement, and includes following a customized time and temperature dependent heating cycle profile for more expensive compounds. This involves careful heating of the material in stages to achieve uniform heating throughout the material pile, and adherence to the temperature profile to produce a quality end product.

Calcining furnaces are known in the art, and include electric furnaces and other direct-fired furnaces. Electric furnaces, which function by blowing air across hot coils, heat around the tray carrying the product and radiate heat from above the product. As a result, the product tends to overheat at the edges and may be insufficiently heated at the center. This non-uniform heating produces a product that is of lower quality compared to a uniformly heated product. Electric furnaces are very expensive to operate, both to generate the required calcining temperatures within the furnace, and also because the post-process generated heat is discarded.

One shortcoming of conventional calcining furnaces is their inability to maintain and hold a uniform mass velocity with a continuous mass flow during temperature changes. The ability to maintain a constant mass flow is critical during calcining because it allows uniformity of heating of the product to be calcined. To calcine, the temperature in the furnace must be changed to follow the calcining temperature profile. In an electric furnace, it is possible to change the temperature of the ceramic coils, but it is cumbersome because of the lengthy time required to change the temperature of the ceramic coil. In a direct-fired furnace, adjustments in temperature are a long, slow process due to the large quantities of material to be heated.

A second shortcoming of conventional calcining furnaces is their inability to operate at higher temperatures. Conventional calcining furnaces are fabricated with many metal components. Metal components reach the end of practical applicability at temperature ranges above 1200 to 1400 degrees F. Although high-tech metals are available for use in these devices, their cost is prohibitive and they have an upper temperature limit as well.

Conventional calcining furnaces often employ fluid bed technology to achieve uniform drying. Conventional fluid bed furnaces are stationary and include large sand or gravel beds that rest on a perforated plate. Air is vigorously forced up through the plate and sand bed in an effort to achieve good drying through turbulence. Though advantageous to combustion drying, this turbulence results in high particulate carryover, and contamination of the calcined product with sand or gravel. Additionally, because of the high particulate carryover, these processes require downstream scrubbing.

Alternatively, rotary kilns are used to tumble the product through gas or air in an effort to achieve uniform drying of a product. This also results in a high carryover of product, and requires fabric filters or other methods to remove particulate from the gas stream.

Conventional fluid bed furnaces work well with uniform materials, but have difficulty with non-uniform materials, that is, materials with chunks in it like coal, and materials that tend to form clinkers.

A calcining furnace is desirable which can achieve uniform drying of material, which allows ease of temperature change for accurate adherence to a temperature profile, and which provides a high quality end product that is free from contamination. A calcining furnace is required which can tolerate high temperatures and temperature cycling. A calcining furnace is required which is non-reactive with the product being calcined, both to ensure a quality end product and to maintain furnace integrity. A calcining furnace is required which employs a fluid bed technology that is both effective and clean.

### SUMMARY OF THE INVENTION

An inventive roller hearth calcining furnace uses a movable fluid bed that is transported through plural heating modules or zones, where each heating module is independently heated using a medium that is indirectly heated.

The inventive furnace is indirectly heated using an all-ceramic oxidizer, an all-ceramic, indirect, air-to-air heat exchanger, and at least one metal heat exchanger, providing a heating medium that is clean and temperature adjustable. In the preferred embodiment, the heating medium is clean, hot air, but may also include other fluids, for example, natural gas, combustion flue gas, and inert gases such as nitrogen. By using an oxidizer fired, all-ceramic, indirect, air-to-air heat exchanger as a heat source, the inventive furnace is fifty percent more efficient than an electric furnace. An additional twenty to thirty percent efficiency is realized because the heat energy generated within the furnace is reclaimed. The indirect heating process described below is clean, so that the product is not contaminated with by-products of direct firing. The all-ceramic oxidizer and all-ceramic, indirect, air-to-air heat exchanger can be fired with oil, coal, natural gas or other means, is impervious to attack from dirty fuels, and produces clean air for productive use. This can be achieved at half the cost of electricity based on firing indirectly with natural gas.

The inventive roller hearth calcining furnace uses a movable fluid bed that replaces conventional non-moving sand or gravel beds. Although described herein with respect to a calcining furnace, those skilled in the art understand that the inventive concept of the movable fluid bed has wide application in the furnace art, including, but not limited to, drying, calcining, gasification, starved air combustion, and incineration. The inventive movable fluid bed includes a permeable silicon carbide ceramic plate that resides within, and is supported by a sagger or tray. The sagger is transported through different temperature zones within a furnace as required by the temperature profile of the material being calcined. This is in contrast to the stationary fluid beds known in the art. The material to be calcined rests on the inventive permeable ceramic plate and air is gently directed up through the porous plate and through the material, providing a diffuse heat source and allowing a very uniform combustion of the material. In the inventive process, air is wafted through the material to be combusted without volatilization or disturbance of the material pile. This is a quiet process that drives water off and leaves clean, calcined material behind with no particulate contamination, as well as producing a clean flue gas.

The permeable silicon carbide plate is strong, hard, and nothing sticks to it. The ceramic material is able to withstand temperatures of up to 2400 degrees F., and easily sheds all debris, making it easy to use in a wide variety of applications, including drying, calcining, gasification, starved air combustion, and incineration. The pore size within the permeable ceramic can be specified, so that the permeable ceramic plate is provided having a pore size that matches the characteristics of the material to be calcined. By optimizing pore size, uniform heating is achieved within the movable fluid bed, and optimal calcining is achieved.

Calcining is the process by which chemically bound water is driven off a substance by heating the substance to a critical temperature. When a substance contains a rare material, the calcining process includes following a customized time and temperature dependent heating cycle profile. This involves careful heating of the material in stages to achieve uniform heating throughout the material pile and adherence to the temperature profile to produce a quality end product.

The indirect heating and heat recovery system in combination with the roller hearth furnace and movable fluid bed provides highly clean and efficient calcining performed with clean hot air. Indirect heating using hot, clean air prevents contamination or unwanted chemical interaction with the product as it is calcined. Such contamination is possible when the furnace is direct fired using natural gas or combustion flue gases.

The calcining time of a typical material within the inventive system was reduced by approximately half due to the efficiencies of the furnace and the fluid bed technology. This is illustrated in FIGS. 2.2 and 2.2.5, where the FIG. 2.2.5 provides a conventional calcining temperature profile that requires approximately 24 hours to complete using prior art furnaces. The inventive furnace completed the calcining process in approximately 10 hours, as illustrated in FIG. 2.2. Additionally, the product that resulted from the inventive calcining process was improved to an extremely high quality due to heating with clean, hot air that results from the indirect firing of this furnace.

The process described herein can be used to recover precious metals from sludge. The sludge is heated in stages to burn off hydrocarbons. Unfortunately, when heated using air, the metals oxidize and are lost. For this application, hot flue gas or natural gas can be fed through the movable fluid beds to drive off the volatiles and leave precious metals behind. Rather than use flue gases to heat clean air, as described above, the reverse is done. That is, air is sent through the heat exchangers to take heat out, and flue gas is directed through the fluid bed.

### BRIEF DESCRIPTION OF THE DRAWINGS

FIG. 2.1 is a schematic view of mass flow through the roller hearth calcining furnace, illustrating how the heating modules within the furnace are indirectly heated using clean air and how heat is recovered from the heating modules.

FIG. 2.2 illustrates the calcining temperature profile of Material A using the inventive system described herein, specifically, an indirectly heated furnace in combination with a movable fluid bed.

FIG. 2.2.5 illustrates the calcining temperature profile of Material A using conventional, prior art calcining furnaces.

FIG. 2.4 is a top sectional view of the roller hearth calcining furnace illustrating the plural saggers within each heating module, and the sagger transport system which encircles the indirect heating and heat recovery plant and includes material loading and unloading stations.

FIG. 2.5 is an exploded side sectional view of an embodiment of the sagger, illustrating sidewalls that are separable from a perforated tray bottom, the permeable ceramic plate residing within and supported by the perforated tray bottom.

FIG. 2.6 is a top view of the sagger of FIG. 2.5 with the sidewalls assembled on the perforated tray bottom, and without the permeable ceramic plate.

FIG. 2.7 is a side sectional view of a second embodiment of a sagger, including sidewalls that are monolithic with the perforated bottom, illustrating the permeable ceramic plate residing upon the bottom within the sagger.

FIG. 2.8 is a top view of the sagger of FIG. 2.7 without the permeable ceramic plate.

FIG. 2.8.5 is a side sectional view of a third embodiment of a sagger, including sidewalls and an open bottom, illustrating the permeable ceramic plate residing upon a support plate adjacent the open bottom of the sagger.

FIG. 2.8.6 is a top view of the sagger of FIG. 2.8.5 without the permeable ceramic plate.

FIG. 2.8.7 is a side sectional, partially exploded, view of a fourth, and preferred, embodiment of a sagger, including sidewalls and an open bottom, illustrating the permeable ceramic plate residing upon a laterally movable perforated drawer adjacent the bottom of the sagger.

FIG. 2.8.8 is an exploded top view of the sagger of FIG. 2.8.7 without the permeable ceramic plate.

FIG. 2.9 is a side sectional view of the roller hearth calcining furnace illustrating the furnace unit adjacent to the indirect heating and heat recovery plant, where a pair of metal heat exchangers reside above a ceramic heat exchanger.

FIG. 2.10 is a side sectional view of the roller hearth calcining furnace of FIG. 9, wherein the section is transverse to the section of FIG. 9, illustrating the positioning of the oxidizer with respect to the metal and ceramic heat exchangers.

FIG. 2.11 is a side sectional view of the heater or calcining module, illustrating the heat input vent at the floor of the module, the heat outlet vents in the ceiling of the module, and the saggers supported by ceramic rollers within the module.

FIG. 2.12 is a partial detail side sectional view of the heating module of FIG. 2.11, illustrating the module wall construction, and positional relationship of the fluid bed and module plenums.

FIG. 2.13 is a side sectional view of the heating module across line A-A of FIG. 2.11 illustrating how sagger pairs fill the open space within the heating module.

FIG. 2.14 is a side sectional view of the heating module across line B-B of FIG. 2.11 illustrating the heat input plenum configuration within the heating module.

FIG. 2.15 is a side sectional view of the heating module across line C-C of FIG. 2.11 illustrating the heat input plenum configuration within the heating module and heat outlet vent configuration.

FIG. 2.16 is a side sectional view of the heating module across line D-D of FIG. 2.11 illustrating the heating module door in a closed position.

FIG. 2.17 is a side sectional view of the heating module across line E-E of FIG. 2.11 illustrating the all-ceramic diffusion plate that directs and diffuses heated gas and prevents debris from obstructing the heat input plenum.

FIG. 2.18 is a side sectional view of the heating module across line F-F of FIG. 2.11 illustrating the heat input plenum configuration within the heating module.

FIG. 2.19 is a side sectional view of the heating module across line G-G of FIG. 2.11 illustrating the heat input plenum configuration within the heating module.

FIG. 2.20 is a side sectional view of the drying module, illustrating the heating tubes extending across module above the fluid bed, heat input below the fluid bed, and adjustable plates over perforations in the diffusion plate to provide adjustability in air flow rate and direction throughout the module.

FIG. 2.21 is a side sectional view of the drying module across line A-A of FIG. 2.20 illustrating the module construction including the side air inlet duct into the plenum.

FIG. 2.22 is a side sectional view of the drying module across line B-B of FIG. 2.20 illustrating the metal diffusion plate that directs and diffuses heated gas and prevents debris from obstructing the heat input plenum. Only one adjustment plate is shown in place over a cluster of perforations in the diffusion plate.

FIG. 2.23 is a side sectional view of the cooling module, illustrating the generally open construction of the unit and configuration of ambient air input below the fluid bed, and adjustable plates over perforations in the diffusion plate to provide adjustability in air flow rate and direction throughout the module.

FIG. 2.24 is a side sectional view of the cooling module across line A-A of FIG. 2.23 illustrating the module construction including the side air inlet duct into the plenum.

FIG. 2.25 is a side sectional view of the cooling module across line B-B of FIG. 2.23 illustrating the metal diffusion plate that directs and diffuses heated gas and prevents debris from obstructing the air input plenum. Only one adjustment plate is shown in place over a cluster of perforations in the diffusion plate.

FIG. 3.0 is a side sectional view of a fifth embodiment of a sagger, including sidewalls and an closed bottom, illustrating the permeable ceramic plate residing upon a lip formed in the sidewall so that it lies above the closed bottom, and illustrating drain holes formed in the sidewall between the permeable ceramic plate and the closed bottom.

FIG. 3.2 is a side sectional view of a sleeve assembly for the rollers, showing that the sleeve extends inwardly from the inside surface of the heating module sidewall to provide a means for guiding the sagger within the heating module.

### DETAILED DESCRIPTION OF THE INVENTION

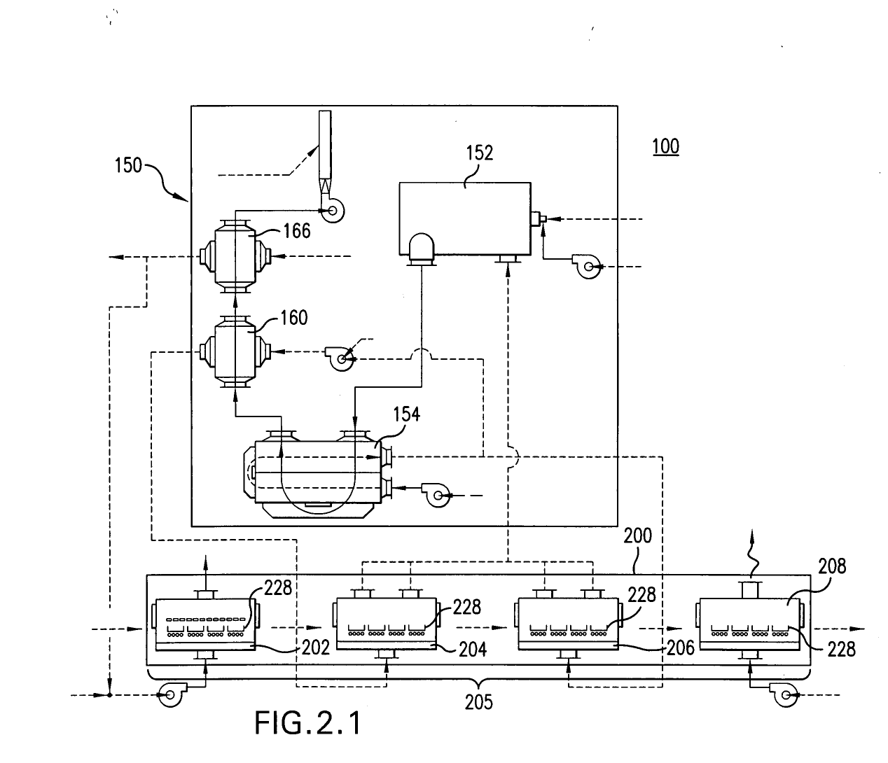

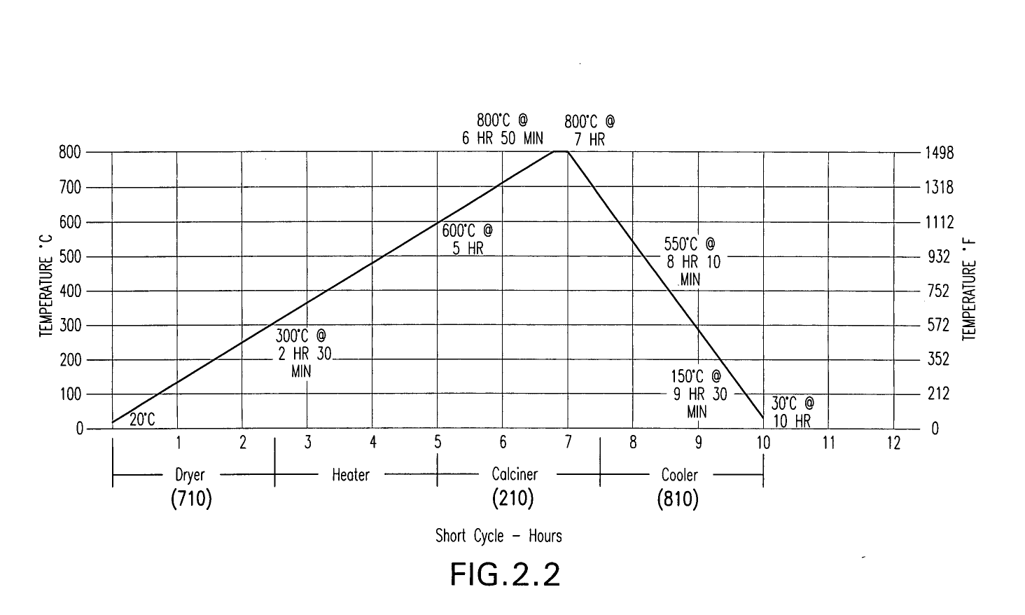

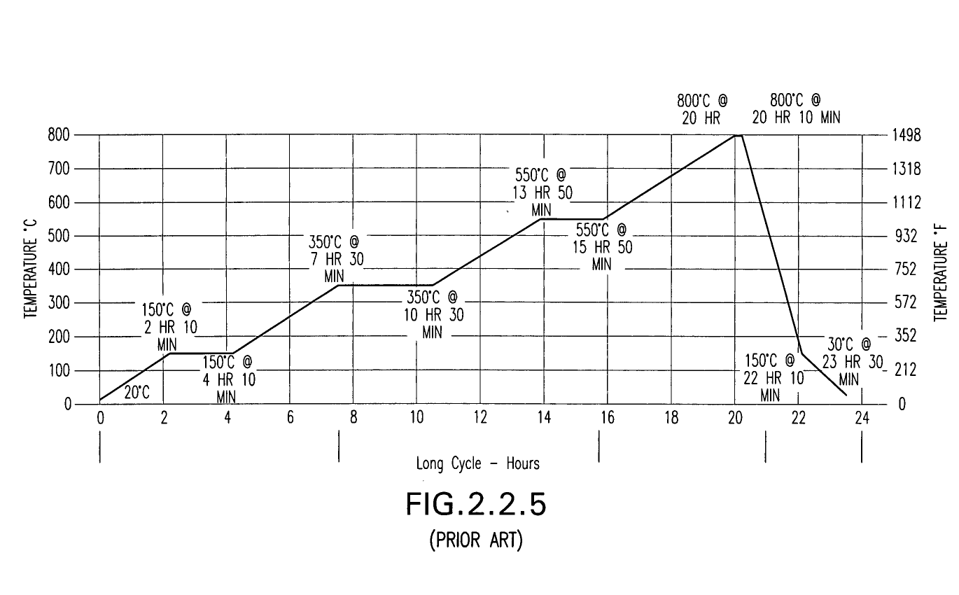

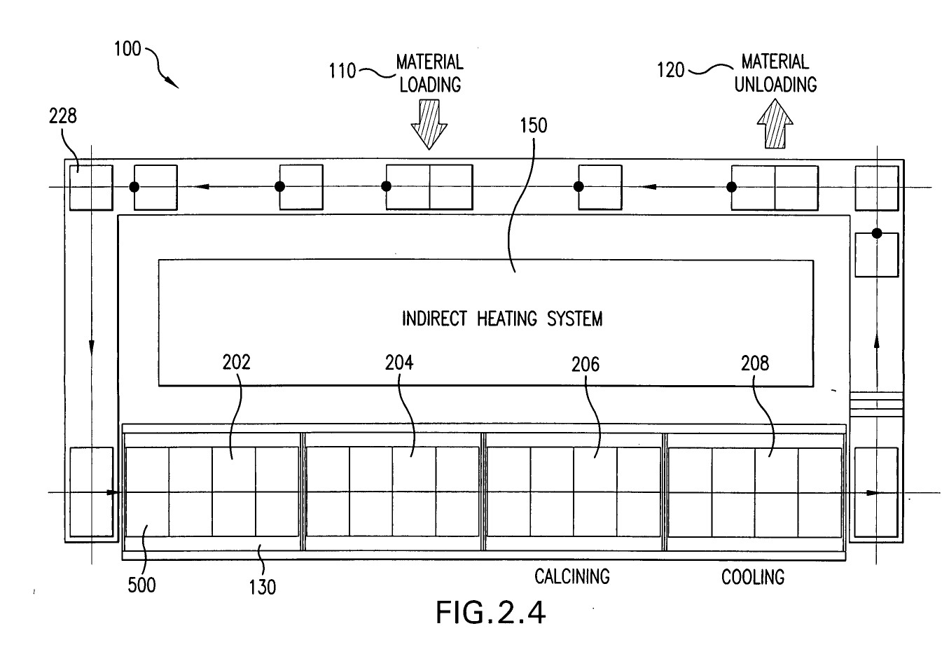

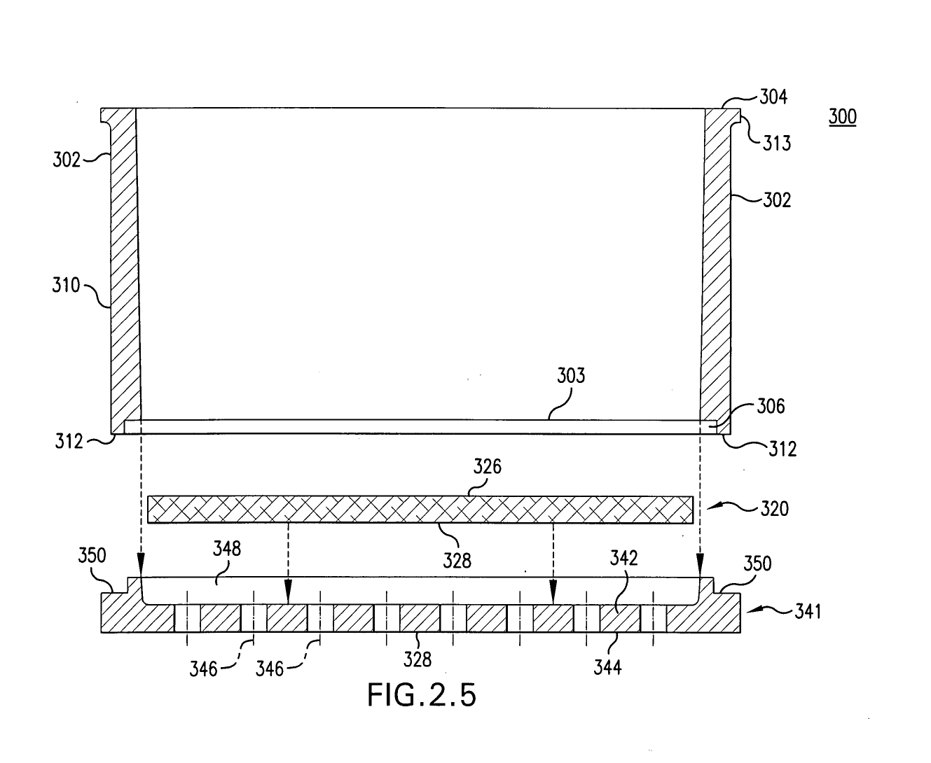

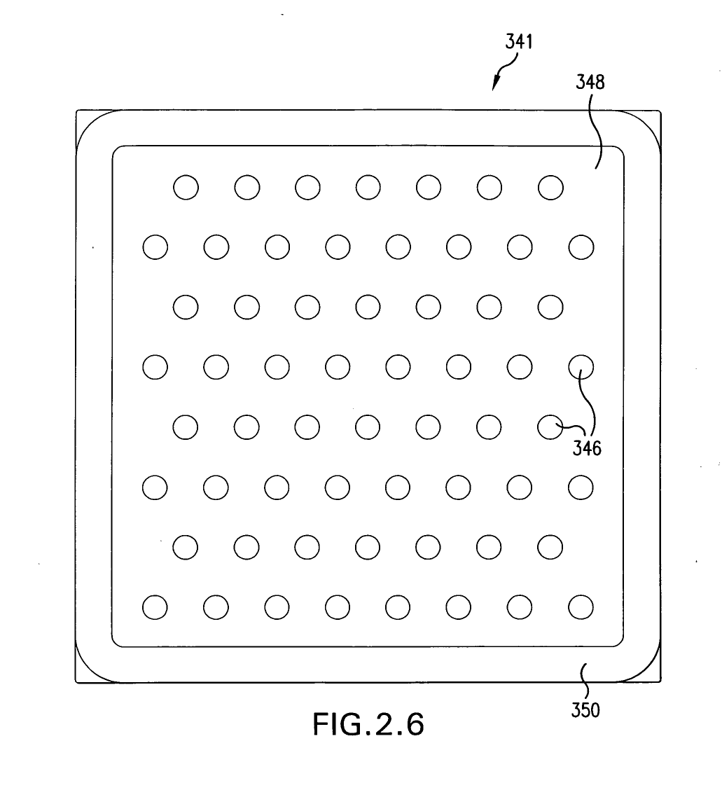

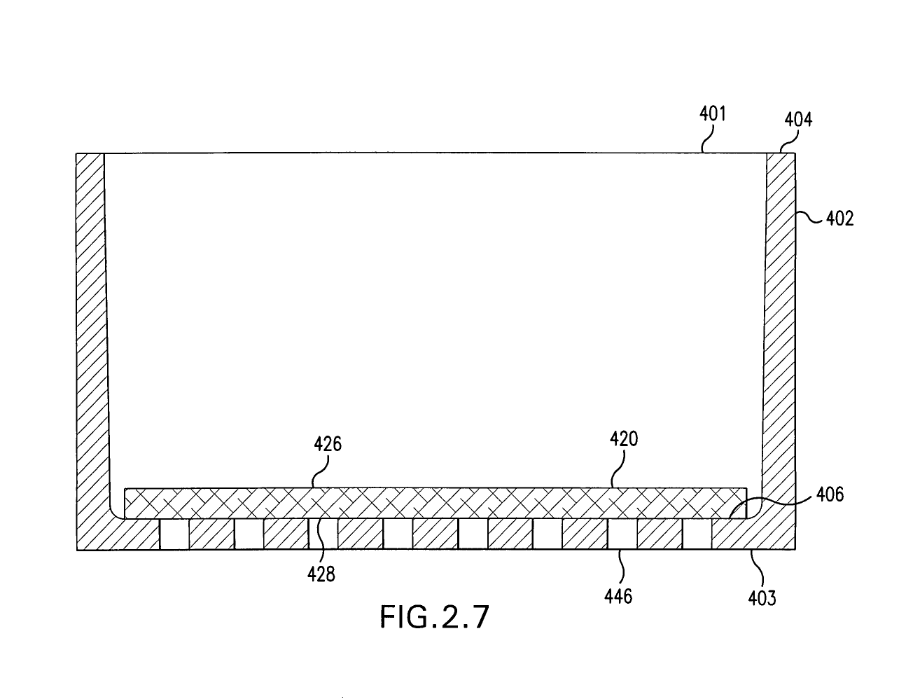

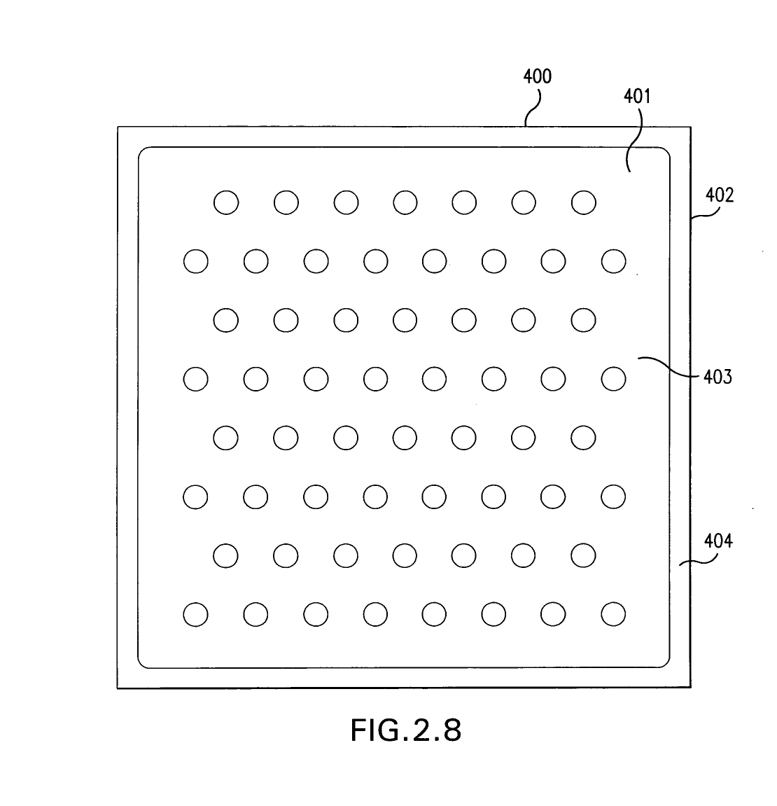

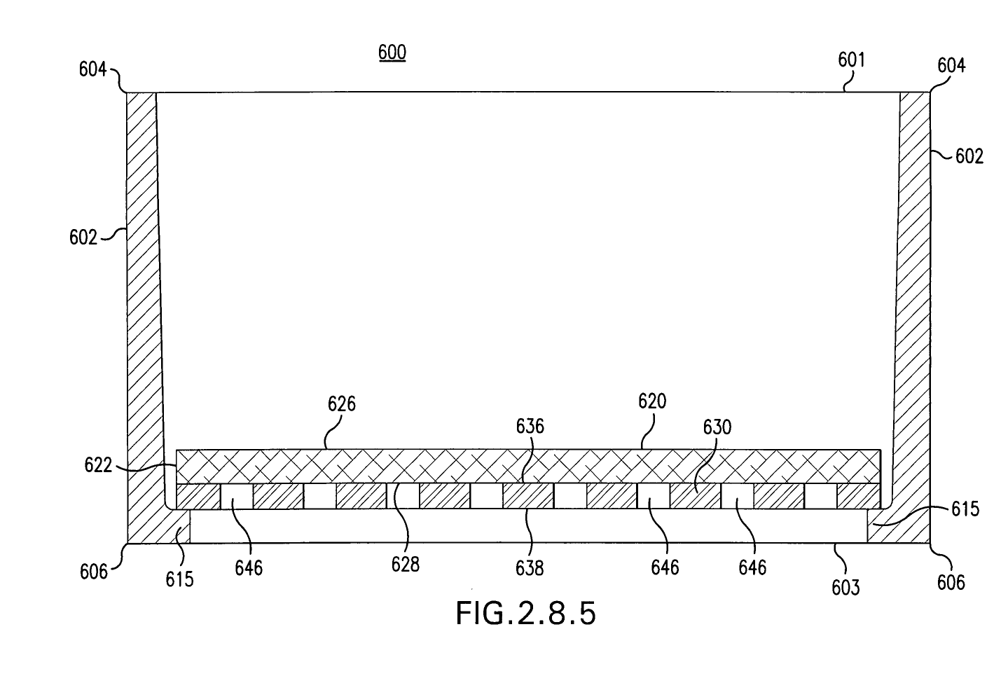

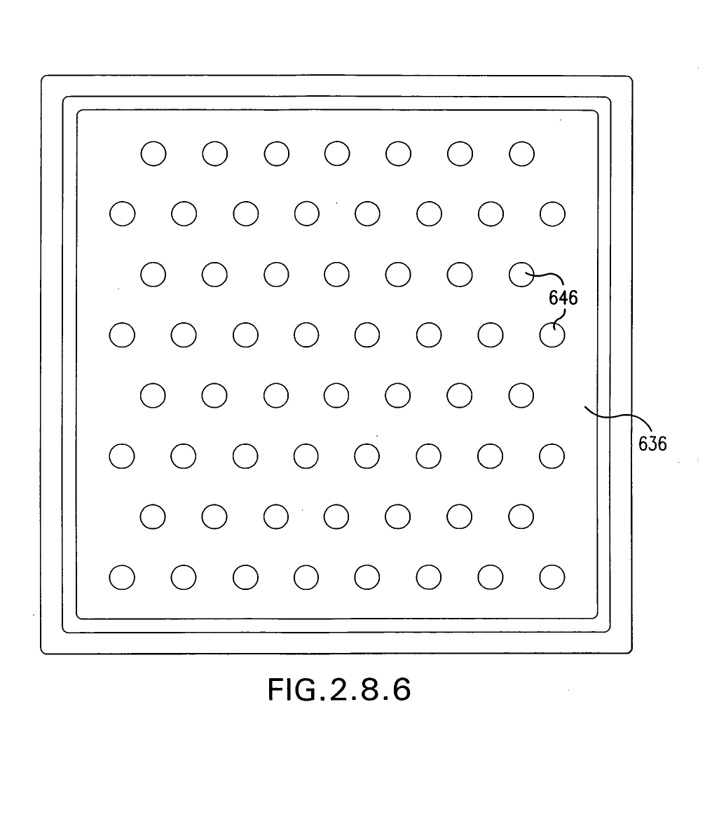

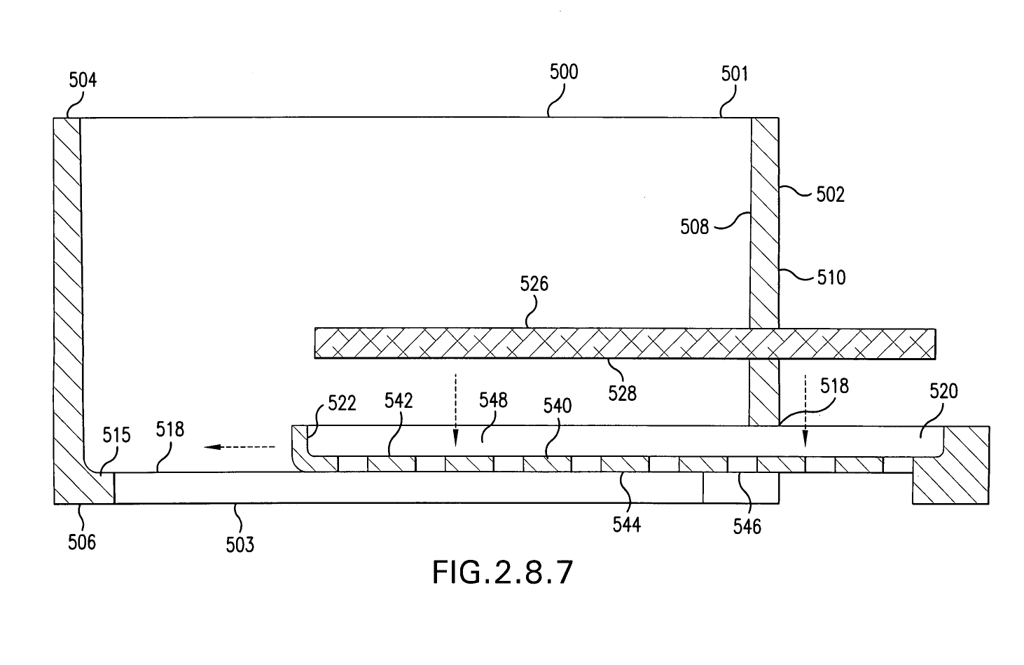

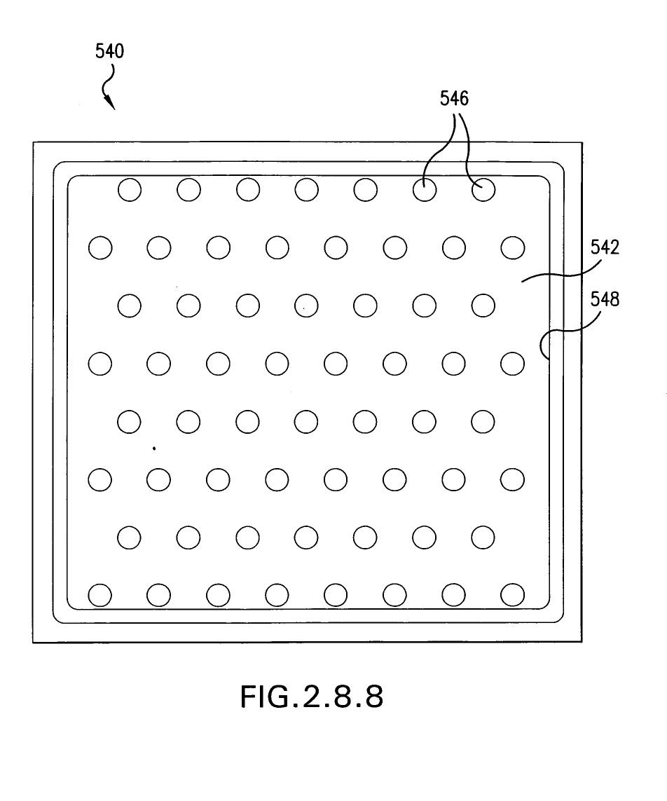

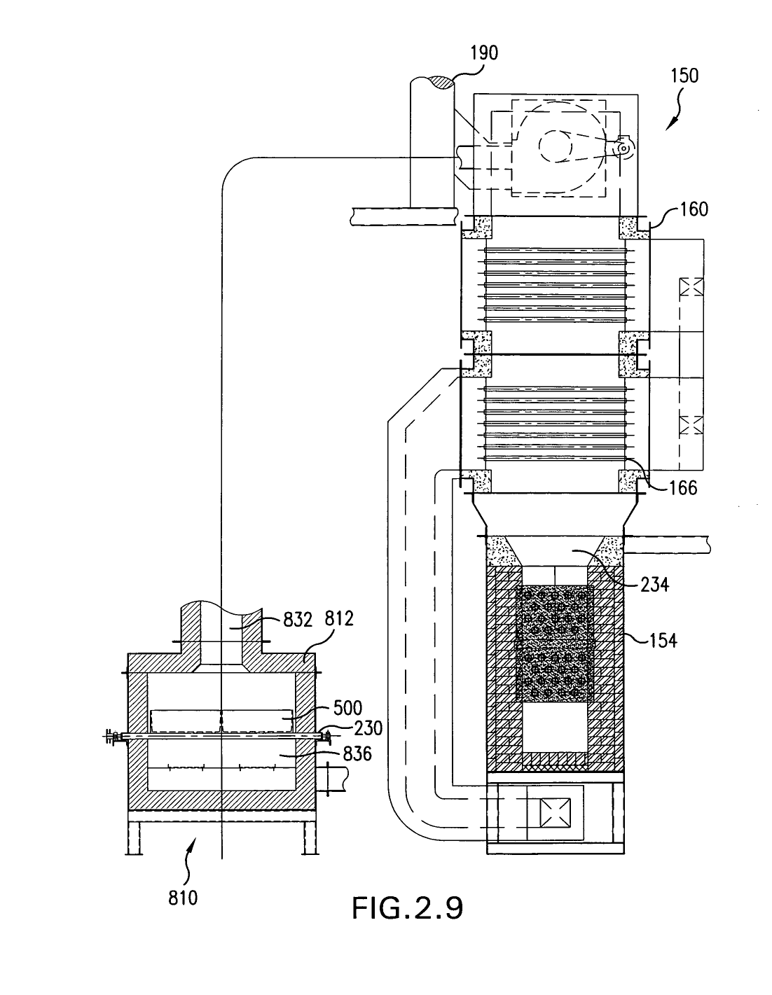

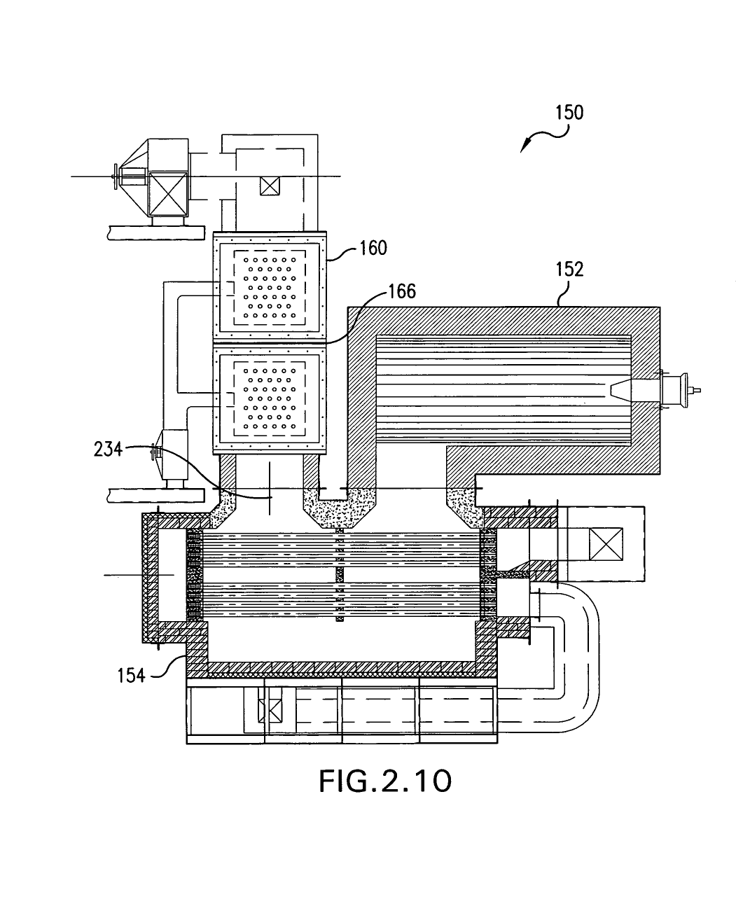

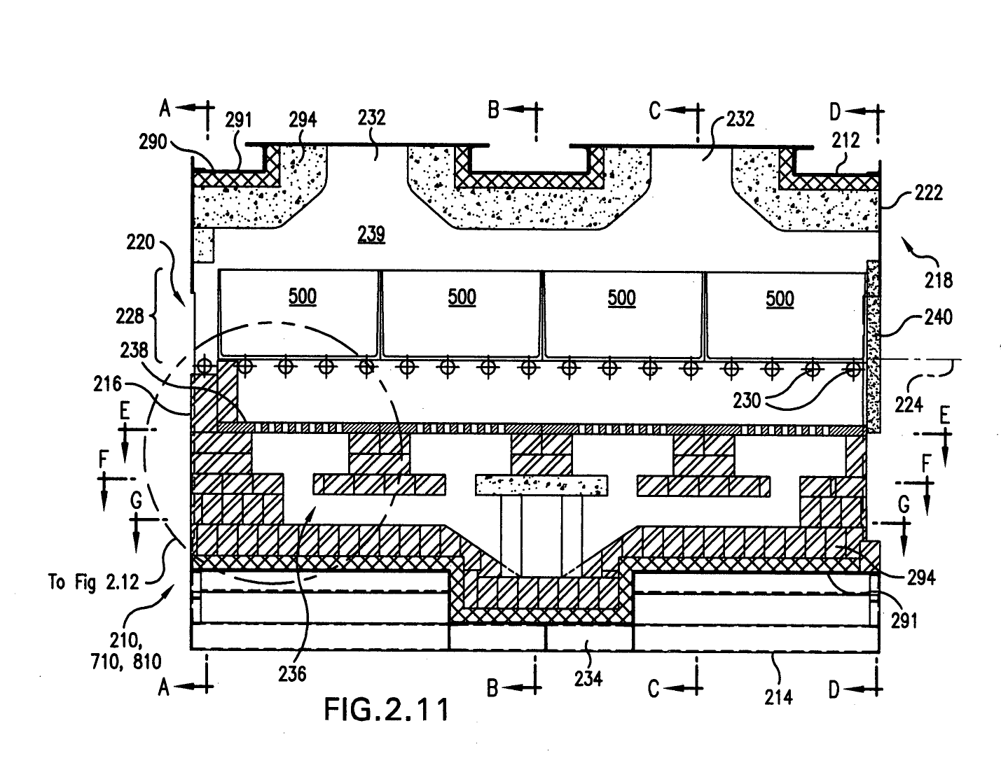

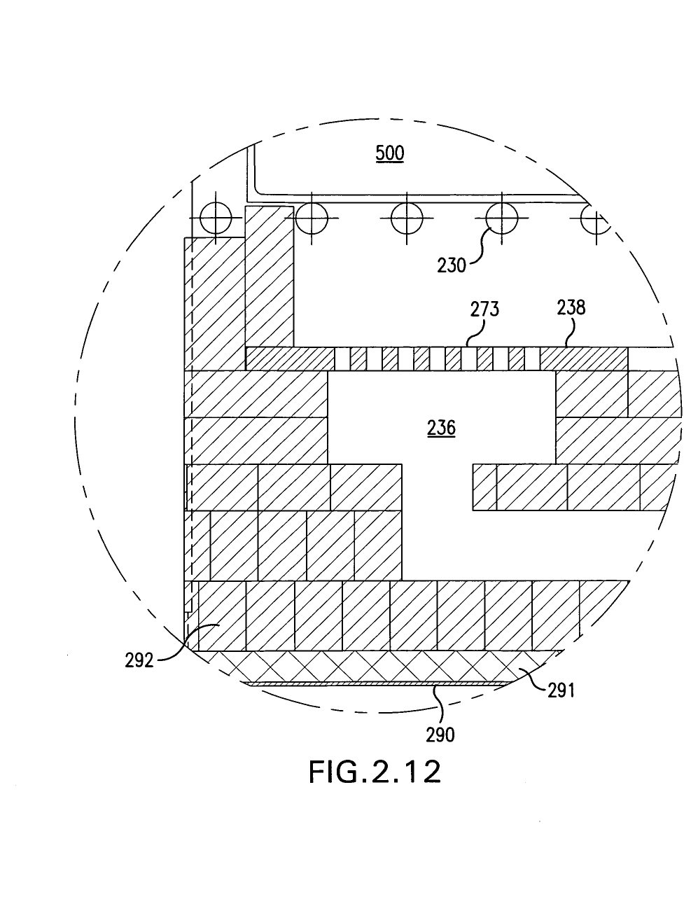

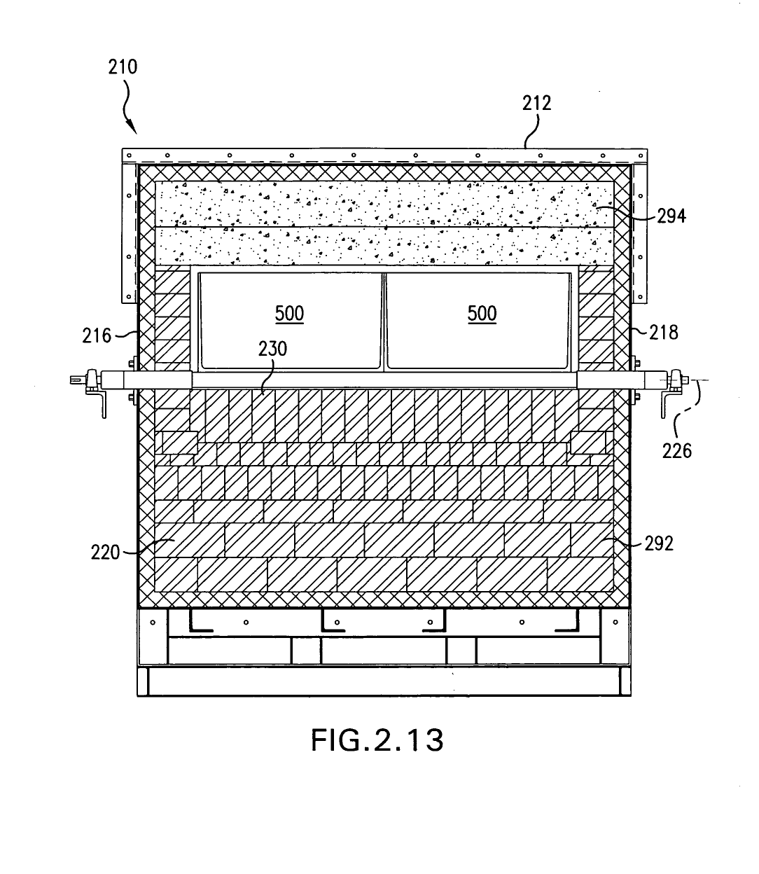

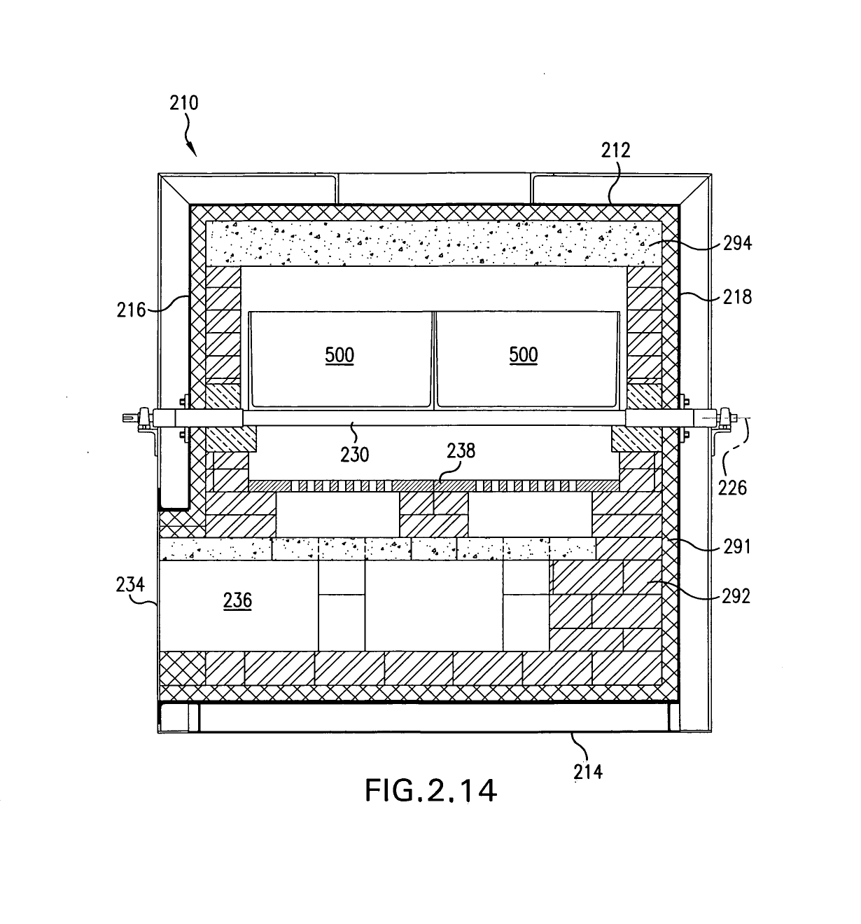

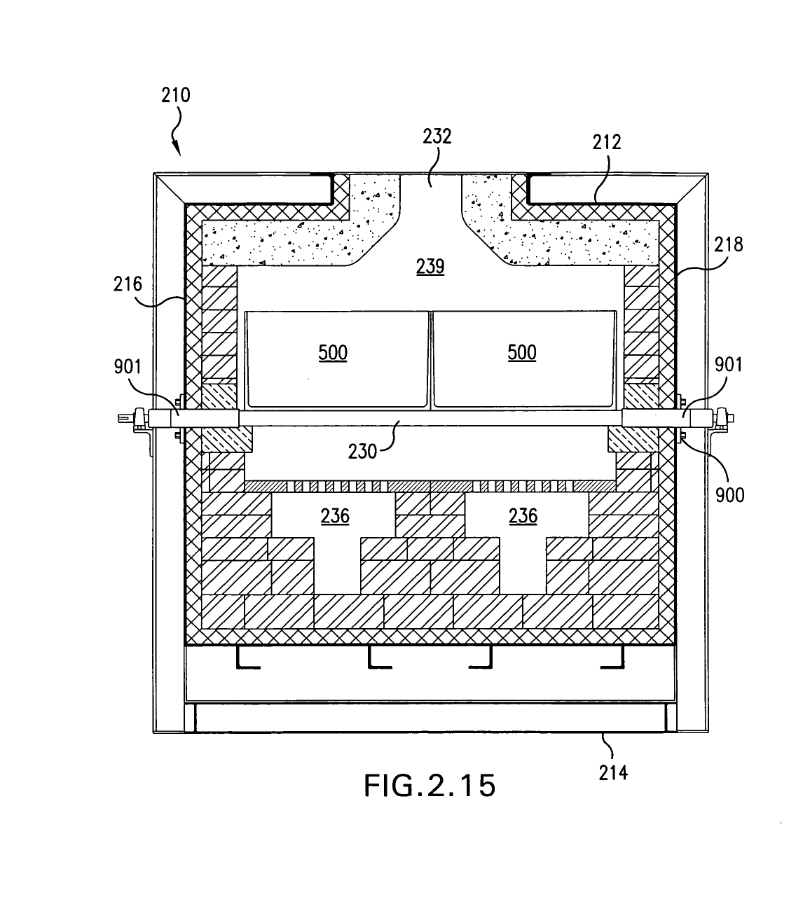

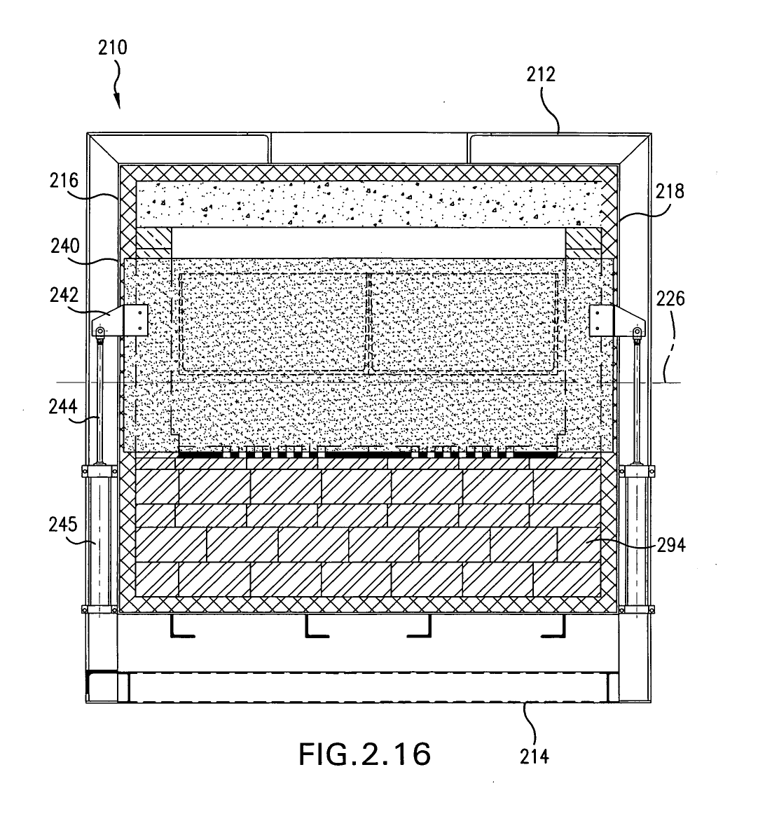

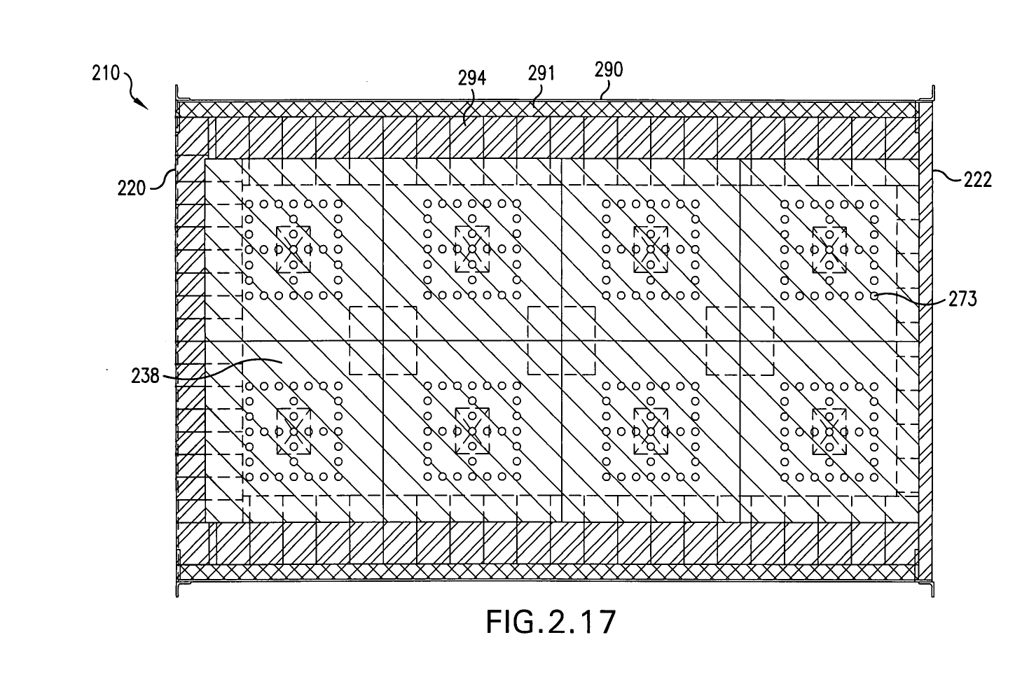

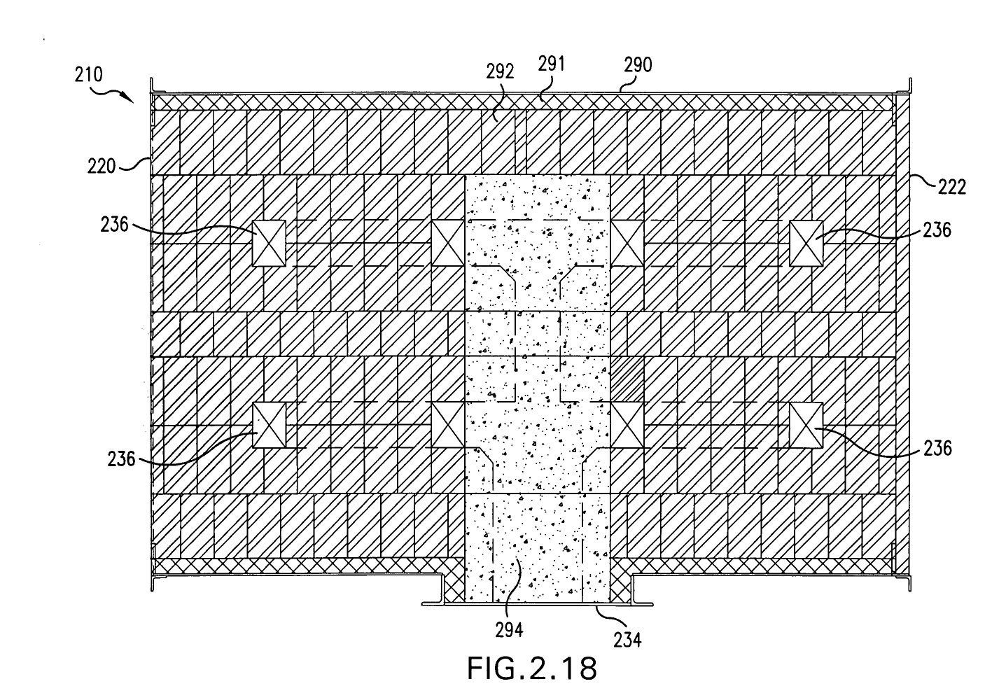

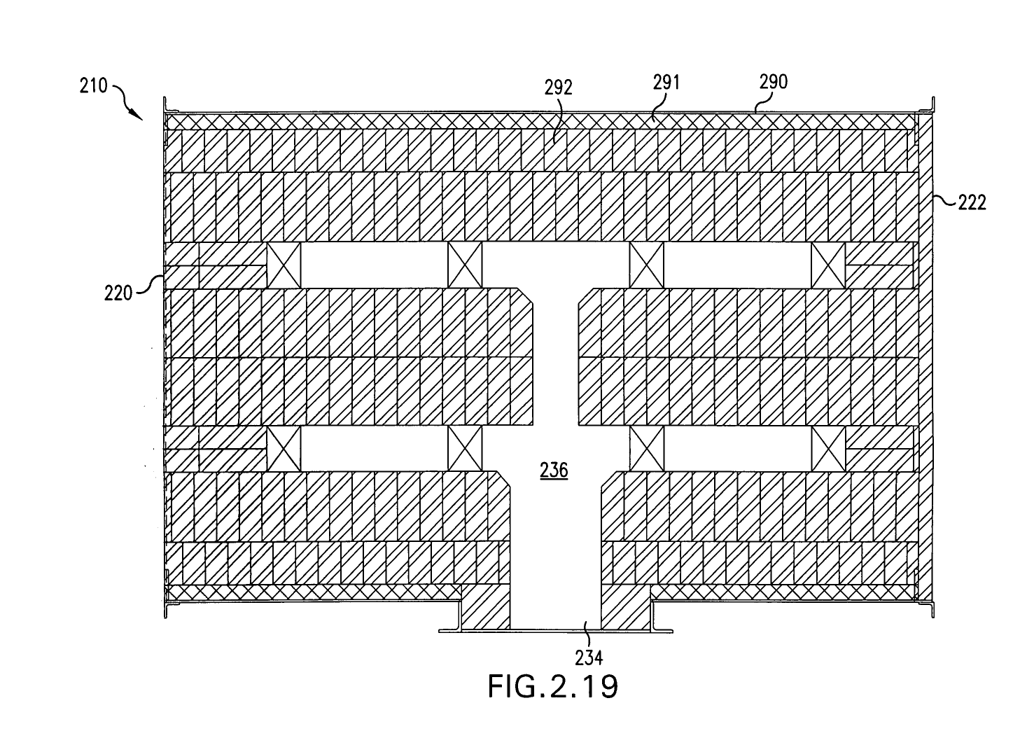

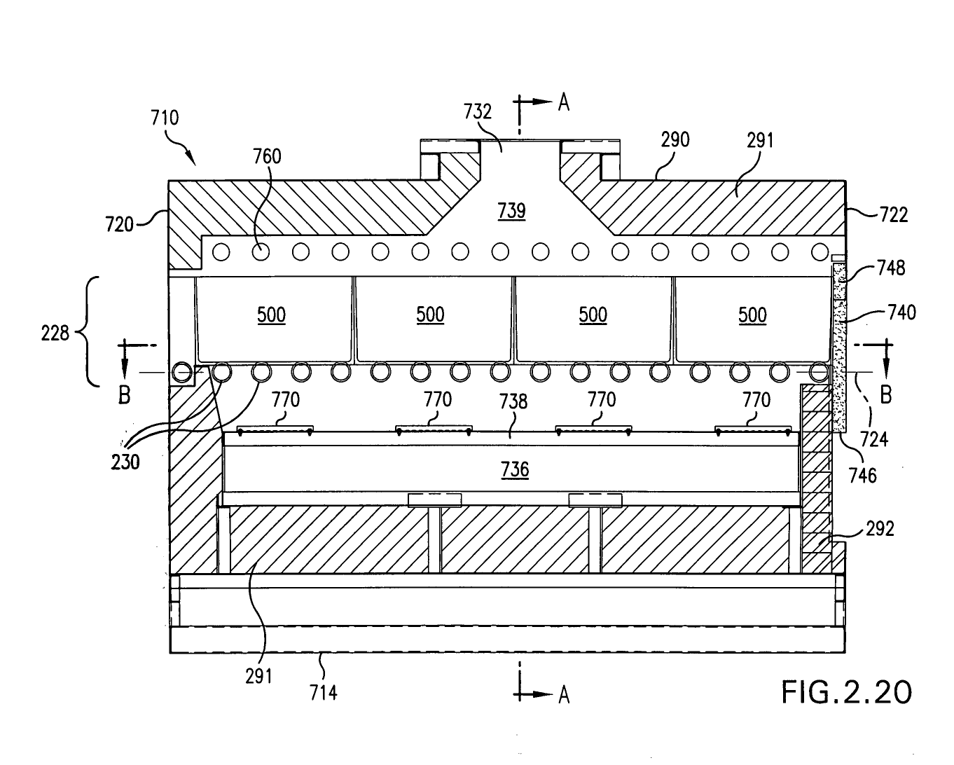

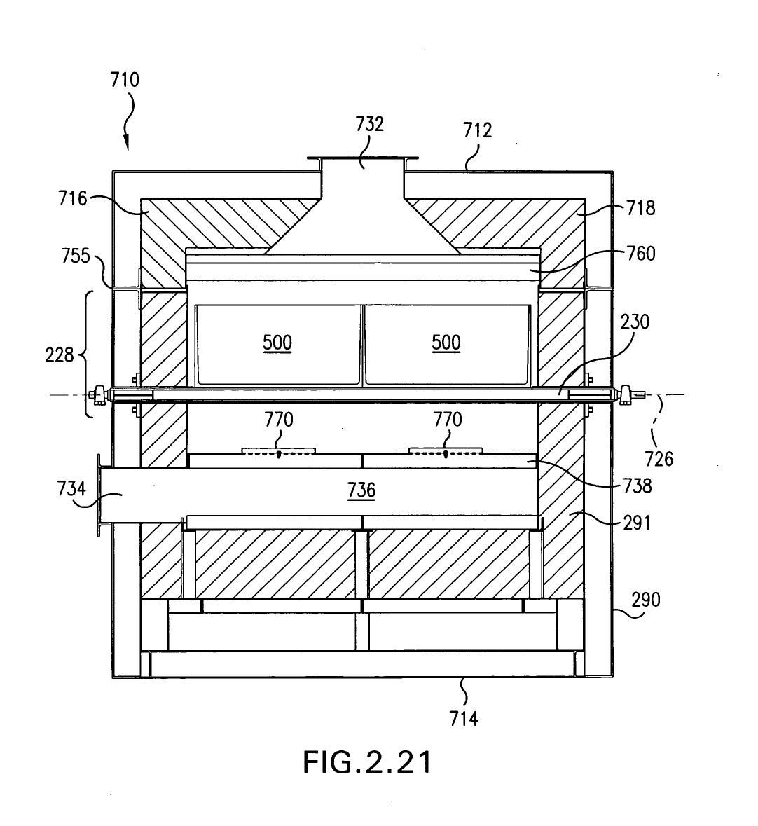

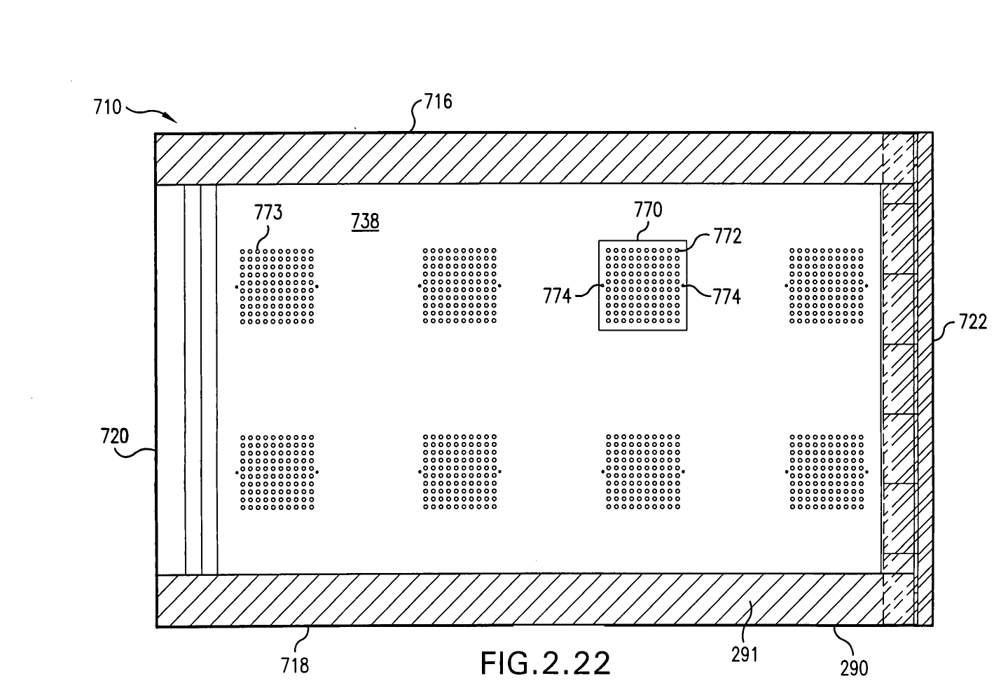

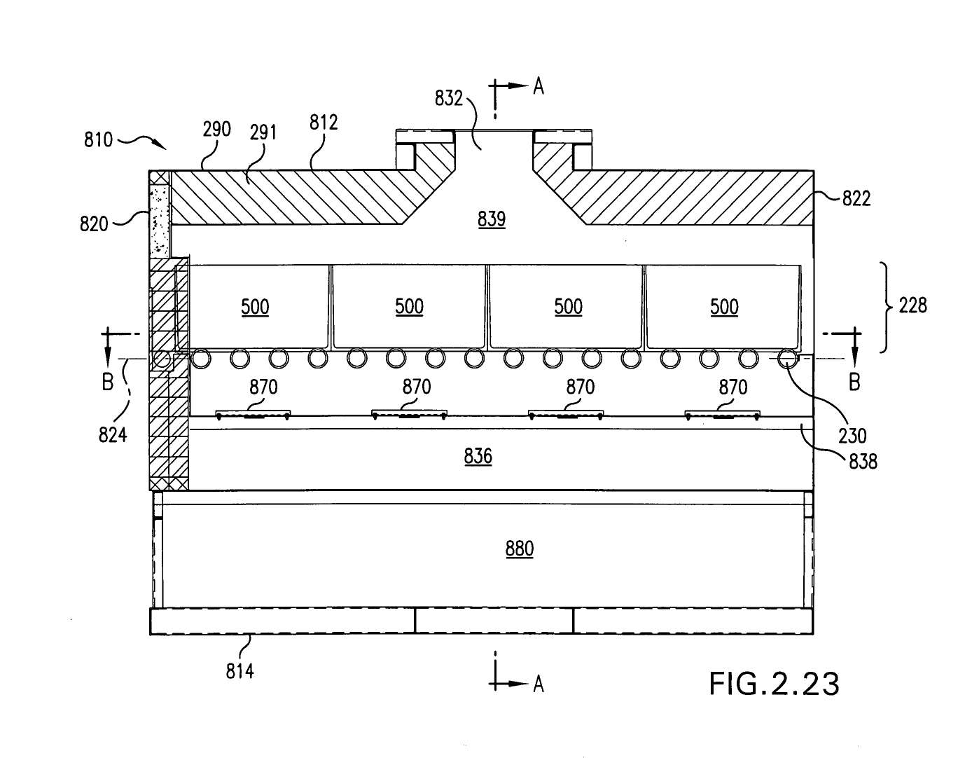

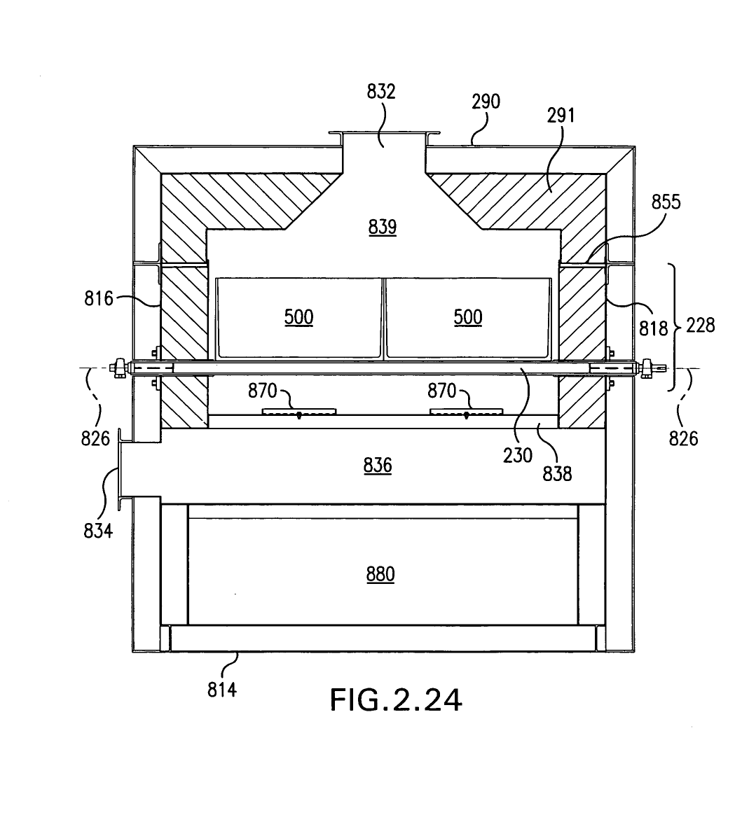

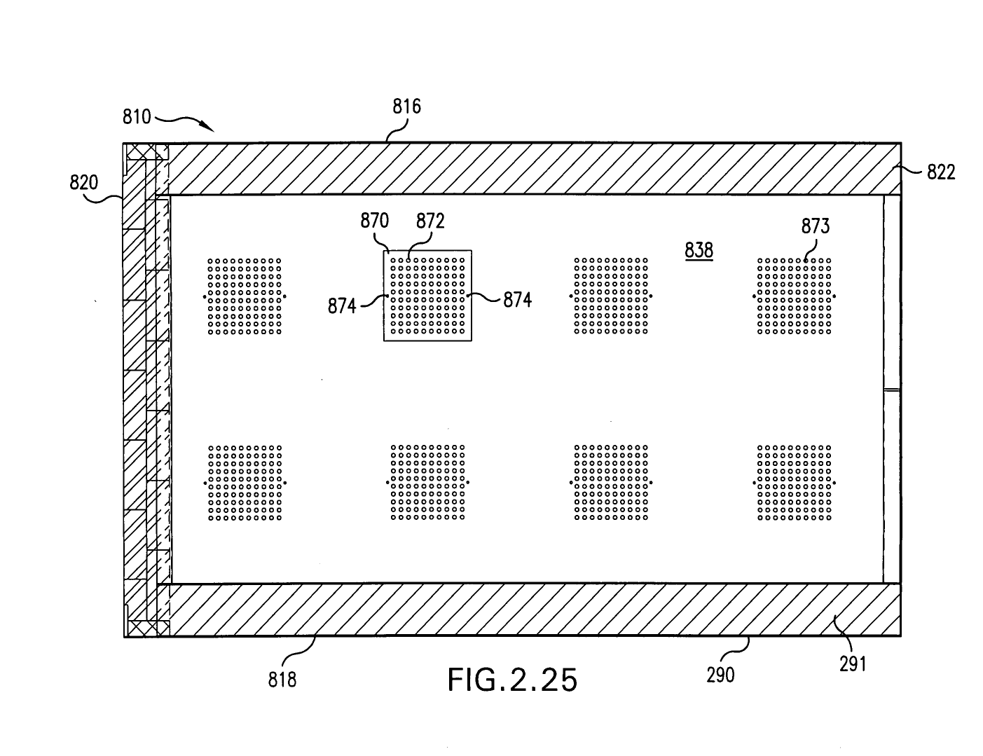

Referring now to the figures, the inventive indirectly fired roller hearth calcining furnace 100 with movable fluid bed 228 (FIG. 2.4) will now be described in detail. Roller hearth furnace 100 includes a furnace unit 200 and an indirect heating and heat recovery system 150, shown schematically in FIG. 2.1. As shown schematically in FIG. 2.4, furnace unit 200 consists of plural sequentially aligned heat modules 205, a movable fluid bed 228, and a transport system 130 that conveys the movable fluid bed 228 from a material loading station 110, through the furnace unit 200, to a material unloading station 120, and returns it to the material loading station 110. Indirect heating and heat recovery system 150 (FIG. 2.1) consists of an oxidizer 152, an all-ceramic indirect air-to-air heat exchanger 154, and one or more metal heat exchangers 160, 166.

Furnace unit 200 is formed of a plurality of heating modules 205 that create a plurality of heating temperature zones 202, 204, 206, 208 within furnace unit 200. Heating modules 205 are serially and sequentially aligned. Each heating module 205 is positioned in sequential order immediately adjacent the other heating modules such that adjacent modules abut each other. Each heating module 205, in combination with the movable fluid bed 228 that passes therethrough, is designed to uniformly heat the material placed in the fluid bed to a desired temperature and chemical state. Upon reaching the desired temperature and chemical state, the material is transported to the next sequential heating module where it is again uniformly heated to the next desired temperature and chemical state. This process is continued through as many heating steps, and thus through as many heating modules 205, as required by the specific calcining application. The number of heating modules 205 used is determined by the specific calcining application, as dictated by the calcining temperature profile for that specific material. For illustrative purposes, a roller hearth furnace 100 designed to calcine Material A will be described. It is understood that calcining a different material than Material A may alter the number of heating modules and the operating temperatures of each heating module, but that the inventive concept remains unchanged.

The calcining temperature profile for Material A is provided in FIG. 2.2. To achieve this heating profile, furnace unit 200 requires four different heating temperature zones. These heating temperature zones include, in sequence from beginning of the calcining process to the end, drying zone 202, heating zone 204, calcining zone 206, and cooling zone 208. Each heating temperature zone is generated using an individual heating module 205. Within the first, or drying zone 202, the material is heated from 20 degrees Celsius to approximately 300 degrees Celsius, drying all surface water from the material. This material is then transferred to the second, or heating zone 204, where it is uniformly heated so that all material within the module is approximately 600 degrees Celsius. This material is then transferred to the third, or calcining zone 206. Within this module, the material is calcined, and reaches peak temperatures of approximately 800 degrees Celsius. Finally, the material is transferred to the last, fourth, or cooling zone 208, where it remains until it has cooled to approximately 20 degrees Celsius.

Heating module 205 has construction that varies depending on whether the heating temperature zone is high temperature 210, low temperature 710, or cooling 810. In the calcining example of Material A, low temperature heating module 710 is used for drying zone 202, high temperature heating module 210 is used for both heating zone 204 and calcining zone 206, and cooling module 810 is used for cooling zone 208.

High temperature heating module 210 (FIGS. 2.11-2.19) comprises a steel outer shell and is completely refractory lined with all-ceramic components. Module 210 has a top or ceiling, 212, a floor 214 that is opposed to ceiling 212, and opposing lateral sidewalls 216, 218 (FIG. 2.13). Material enters module 210 through an opening in the inlet sidewall 220, and exits each heating module through an opening in the outlet sidewall 222. Longitudinal axis 224 extends through each respective heating module perpendicular to the respective inlet and outlet sidewalls, such that it coincides with the direction of travel of material through the furnace unit 200. Transverse axis 226 extends perpendicularly to longitudinal axis 224.

Heat is directed into module 210 up through an inlet duct 234 in floor 214, and is received within vacancies or plenums 236 adjacent floor 214. Plenums 236 are sized and shaped to direct heat upwards toward movable fluid bed 228. Fluid bed 228 is suspended and transported within the open interior space 239 of the heating module, and consists of inventive saggers 500 supported by all ceramic rollers 230. An all-ceramic perforated diffusion plate 238 separates open interior space 239 from plenums 236. Diffusion plate 238 is provided with plural groups of clustered perforations 273 that serve to diffuse the upwardly flowing heat, and direct it uniformly about fluid bed 228. A preferred perforation configuration for diffusion plate 238 is shown in FIG. 2.17. Note that the diffusion plate openings 273 are arranged to reflect the configuration of saggers 500 within open interior space 239. Additionally, diffusion plate 238 prevents debris from entering plenums 236. After passing upwards through movable fluid bed 228, heat is vented from and exits each respective heating module through at least one outlet duct 232 formed in ceiling 212.

High temperature heating module 210 is provided with a cast refractory lining 294 along ceiling 212 that is separated from the outer steel shell 290 by a layer of insulation 291. Refractory brick 294 is used to form plenums 236 above floor 214, and extends upward along sidewalls 216, 218. A layer of insulation 291 is provided between outer steel shell 290 and refractory brick 294.

Material is transported through the open interior space 239 of high temperature heating module 210 using saggers 500 in combination with all-ceramic rollers 230. Rollers 230 are elongate hollow ceramic tubes

Rollers 230 extend between respective lateral sidewalls 216, 218 (that is, transversely to the direction of travel) and reside approximately mid way between ceiling 212 and floor 214. Rollers 230 are supported within sidewalls 216, 218 by roller sleeve assembly 900. Saggers 500 are supported within and moved through module 210 via rollers 230. Rollers 230 are driven by conventional means, which may include, but are not limited to, drive chain and sprocket assemblies positioned externally of the module.

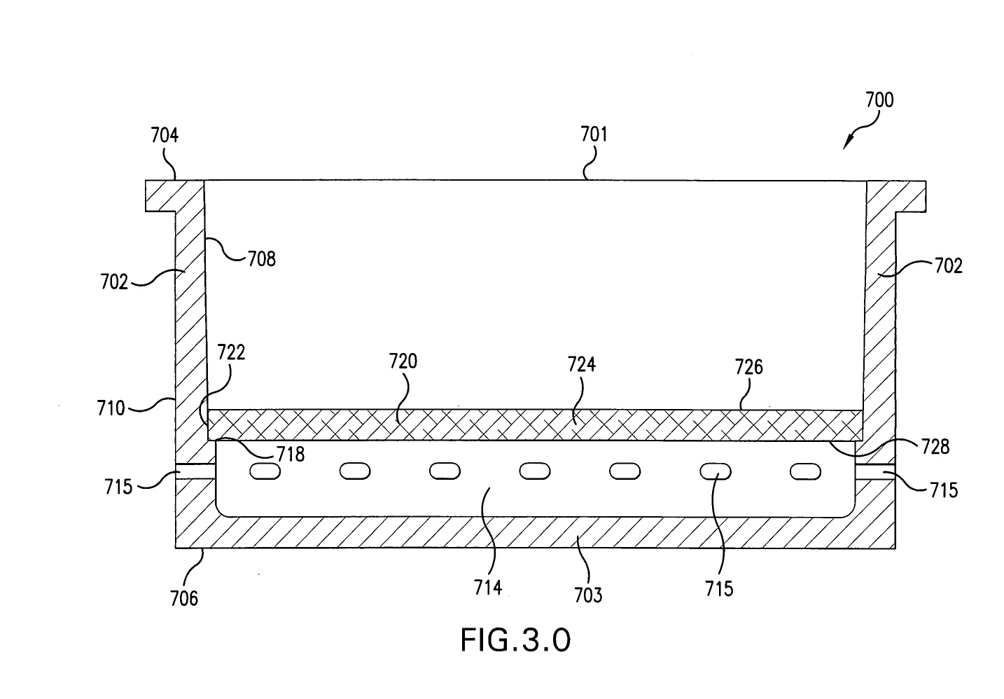

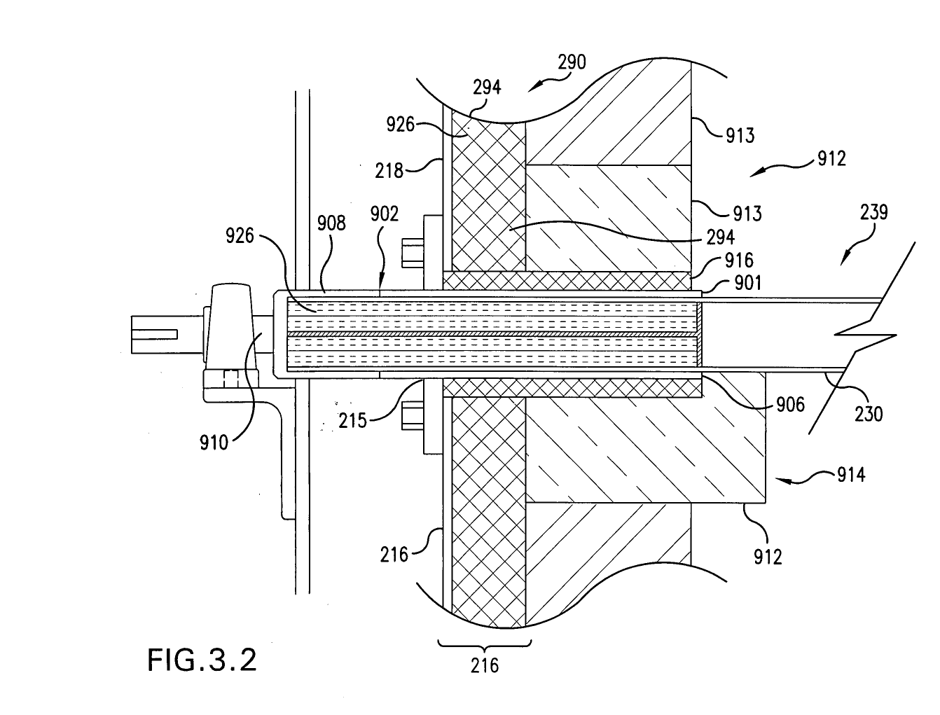

Roller sleeve assembly 900 (FIG. 3.2) includes sleeve 901, cast block housing 912, cap 908, and insulation 916. Sleeve 901 is an elongate tube that extends through an opening 215 in sidewall 216, 218. Sleeve 901 is provided in a length that is greater that the thickness of side wall 216, 218 so that opposed ends 902, 906 of sleeve 901 protrude from side wall 216, 218. For example, first end 902 resides outside module 210 and second end 906 extends into the open interior space 239 of module 210. Second end 906 acts as a guide for sagger 500 within module 210 and replaces the bar or guide used for this purpose formed on the interior of the sidewall of conventional furnaces. Use of second end 906 as a sagger guide provides less wear on sagger 500 than the conventional style guide. Sleeve 901 may be fixed relative to the sidewall so that roller 230 rotates within sleeve 901. Alternatively, sleeve 901 may be allowed to rotate with roller 230. Sleeve 901 may be formed of metal or ceramic, as required by the specific application.

Sleeve 901 is supported in opening 215 using a cast block housing 912. Block housing 912 surrounds roller 230, has an upper portion 913 which lies flush with cast refractory layer 294, and a lower portion 914 which extends into the open interior space 239 such that it partially surrounds a lower portion of roller 230 adjacent side wall 216, 218. This inward extension prevents heating fluid from flowing up around the outside of saggers 500, and directs the heating fluid up through the bottom of sagger 500. A layer of insulation 916 is provided between block housing 912 and roller 230. This layer is used for positional adjustment of roller 230 within housing 912, and as a protective particulate barrier. Additional insulation 926 is provided within each terminal end of roller 230. Insulation 926 protects bearings and roller driving components from heat damage conducted through roller 230. Roller terminal end cap 908 maintains insulation 926 within roller 230 and includes an elongated outer end 910 for securing roller 230 to support and driving components.

Low temperature heating module 710 (FIGS. 2.20-2.22) comprises a steel outer shell and is partially refractory lined. Module 710 has a top or ceiling, 712, a floor 714 that is opposed to ceiling 712, and opposing lateral sidewalls 716, 718. Material enters module 710 through an opening in the inlet sidewall 720, and exits each heating module through an opening in the outlet sidewall 722. Longitudinal axis 724 extends through each respective heating module perpendicular to the respective inlet and outlet sidewalls, such that it coincides with the direction of travel of material through the furnace unit 200. Transverse axis 726 extends perpendicularly to longitudinal axis 724.

Heat is directed into module 710 through an inlet duct 734 in sidewall 716, and is received within vacancies or plenums 736 adjacent floor 714. Plenums 736 are sized and shaped to direct heat upwards toward movable fluid bed 228. Fluid bed 228 is suspended and transported within the open interior space 739 of the heating module, and consists of inventive saggers 500 supported by all-ceramic rollers 230. A steel perforated diffusion plate 738 separates open interior space 739 from plenums 736.

Diffusion plate 738 is provided with plural groups of clustered perforations 773 that serve to diffuse the upwardly flowing heat, and direct it uniformly about fluid bed 228. A preferred perforation configuration for diffusion plate 738 is shown in FIG. 2.22. Note that the diffusion plate openings 773 are arranged to reflect the configuration of saggers 500 within open interior space 739. Additionally, diffusion plate 738 prevents debris from entering plenums 736.

Diffusion plate 738 is also provided with plural adjustable plates 770. Each plate 770 is a thin, perforated steel plate that overlies an individual group of clustered perforations 773 in diffusion plate 738. Perforations 772 on adjustable plate 770 are configured to allow exact alignment with perforations 773 in diffusion plate 738. By intentional partial misalignment of adjustable plate 770, airflow through perforations 772, 773 can be partially or completely obstructed, thereby controlling and directing air flow through that portion of diffusion plate 738. FIG. 2.22 illustrates diffusion plate 738 having a single adjustable plate 770 secured thereon. In use, each of the eight groups of perforations 773 is provided with an adjustable plate 770. In the preferred embodiment, adjustable plates 770 are positioned so that perforations adjacent air inlet duct 734 are partially obstructed, and perforations located distant air inlet duct are unobstructed. After passing upwards through movable fluid bed 228, heated air is vented from and exits low temperature heating module 710 through at least one outlet duct 705 formed in ceiling 712.

Low temperature heating module 710 is provided with a thick insulation lining 291 along ceiling 712, along inlet sidewall 720, and between floor 714 and plenum 736. Refractory brick 294 is used line outlet wall 722 because this wall abuts high temperature heating module 210.

Material is transported through the open interior space 739 of low temperature heating module 710 using saggers 500 in combination with metal rollers 230′. Rollers 230′ extend between and are supported within respective lateral sidewalls 716, 718 (that is, transversely to the direction of travel) and reside approximately mid way between ceiling 712 and floor 714. Saggers 500 are supported within and moved through module 710 via rollers 230′. Each end of each metal roller 230′ is provided with a guide bushing 903, the guide bushing encircling the metal roller 230′ and positioned adjacent each respective lateral side wall 716, 718. Guide bushing 903 provides a guide for saggers 500 within module 710. Rollers 230′ are driven by conventional means, which may include, but are not limited to, drive chain and sprocket assemblies positioned externally of the module.

Cooling module 810 (FIGS. 2.23-2.25) comprises a steel outer shell and is partially lined with insulation. Module 810 has a top or ceiling, 812, a floor 814 that is opposed to ceiling 812, and opposing lateral sidewalls 816, 818. Material enters module 810 through an opening in the inlet sidewall 820, and exits each heating module through an opening in the outlet sidewall 822. Longitudinal axis 824 extends through each respective heating module perpendicular to the respective inlet and outlet sidewalls, such that it coincides with the direction of travel of material through the furnace unit. Transverse axis 826 extends perpendicularly to longitudinal axis 824.

Ambient air is directed into module 810 through an inlet duct 834 in sidewall 816, and is received within vacancies or plenums 836 adjacent floor 814. Plenums 836 are sized and shaped to direct ambient air upwards toward movable fluid bed 228. Fluid bed 228 is suspended and transported within the open interior space 839 of the cooling module, and consists of inventive saggers 500 supported by all-ceramic rollers 230. A steel perforated diffusion plate 838 separates open interior space 839 from plenums 836.

Diffusion plate 838 is provided with plural groups of clustered perforations 873 that serve to diffuse the upwardly flowing ambient air, and direct it uniformly about fluid bed 228. A preferred perforation configuration for diffusion plate 838 is shown in FIG. 2.25. Note that the diffusion plate openings 873 are arranged to reflect the configuration of saggers 500 within open interior space 839. Additionally, diffusion plate 838 prevents debris from entering plenums 836.

Diffusion plate 838 is also provided with plural adjustable plates 870. Each plate 870 is a thin, perforated steel plate that overlies an individual group of clustered perforations 873 in diffusion plate 838. Perforations 872 on adjustable plate 870 are configured to allow exact alignment with perforations 873 in diffusion plate 838. By intentional partial misalignment of adjustable plate 870, airflow through perforations 872, 873 can be partially or completely obstructed, thereby controlling and directing airflow through that portion of diffusion plate 838. FIG. 2.25 illustrates diffusion plate 738 having a single adjustable plate 870 secured thereon. In use, each of the eight groups of perforations 873 is provided with an adjustable plate 870. In the preferred embodiment, adjustable plates 870 are positioned so that all perforations 873 are unobstructed. After passing upwards through movable fluid bed 228, air is vented from and exits cooling module 810 through at least one outlet duct 832 formed in ceiling 812 (See also FIG. 2.9).

Cooling module 810 is provided with a thick insulation lining 291 along ceiling 712 only. Refractory brick 294 is used line inlet wall 820 because this wall abuts high temperature heating module 210. Open space exists between plenum 836 and floor 814.

Material is transported through the open interior space 839 of cooling module 810 using saggers 500 in combination with metal rollers 230′. Rollers 230′ extend between and are supported within respective lateral sidewalls 816, 818 (that is, transversely to the direction of travel) and reside approximately mid way between ceiling 812 and floor 814. Saggers 500 are supported within and moved through module 810 via rollers 230′. Each end of each metal roller 230′ is provided with a guide bushing 903, the guide bushing encircling the metal roller 230′ and positioned adjacent each respective lateral side wall 816, 818. Guide bushing 903 provides a guide for saggers 500 within module 810. Rollers 230′ are driven by conventional means, which may include, but are not limited to, drive chain and sprocket assemblies positioned externally of the module.

Inventive all-ceramic saggers 500 (FIG. 2.8.7, 2.8.8) are the basis of the movable fluid bed 228. In the preferred embodiment, each sagger 500 comprises sidewalls 502, an open top 501 and bottom 503. Sidewalls 502 are vertically oriented, are closed in section, and are provided with an upper edge 504 and a lower edge 506. Lower edge 506 is provided with an inwardly extending lip 515 that extends continuously about the periphery of sidewall 502. In the preferred embodiment, sidewalls 502 are square in section. However, it is well within the scope of this invention to provide sidewalls 502 having sectional shapes that are polygonal or arcuate, as required by the specific application. Slot 518 is provided on one side of sagger 500, positioned immediately above lip 515 and extending between inside surface 508 and outside surface 510 of sidewall 502.

Bottom 503 of sagger 500 includes fluid permeable plate 520 and support plate 540. Fluid permeable plate 520 is planar and has an upper surface 526, a lower surface 528 opposed to upper surface 526 and separated from it by the thickness of the plate. Fluid permeable plate 520 is bounded by peripheral edge 522. Fluid permeable plate 520 is formed of permeable ceramic and consists of ceramic threads or fibers which are entwined and interwoven to form a strong, hard, air permeable, non-stick, porous mat. Employment of this permeable ceramic plate within sagger 500 is key to achieving a fluid bed within furnace unit 200.

Fluid permeable plate 520 is supported in a horizontal orientation within sagger 500 by support plate 540. Support plate 540 is provided with an upper surface 542, a lower surface 544 that is opposed to upper surface 542, and a plurality of through holes or perforations 546 that extend between the upper surface 542 and lower surface 544. Support plate 540 resides within sagger 500 so that the periphery of lower surface 544 of support plate 540 rests upon lip 515 of sidewalls 502.

Depression 548 is formed in upper surface 542 of support plate 540 which is sized and shaped to received fluid permeable plate 520 therein such that plate 520 fills depression 548, and such that upper surface 526 of fluid permeable plate 520 lies flush with upper surface 542 of support plate 540. In use, fluid permeable plate 520 resides within depression 548. Perforations 546 in support plate 540 are sized to allow generous heated fluid flow upward through fluid permeable plate 520.

In use, sagger 500 is filled with a material so that the material rests on upper surface 526 of fluid permeable plate 520 and is contained within sidewalls 502. Sagger 500 is then transported sequentially through each heating zone until the desired product is achieved. At the end of this process, material is removed from sagger 500 in the following manner: Fluid permeable plate 520 and support plate 540 are withdrawn from sagger 500 through slot 518 in sidewall 502. Slot 518 is rectangular in shape, is sized to just allow passage of support plate 540 therethrough. The action of drawing support plate 540 through slot 518 causes the material resting on fluid permeable plate 520 to be wiped from upper surface 526 of fluid permeable plate 520. The material is trapped within sagger 500 by sidewall 502, and drops down through the opening in bottom 503 created by the removal of support plate 540.

A second embodiment sagger 400 (FIG. 2.7, 2.8) may be substituted for preferred embodiment sagger 500. Sagger 400 comprises sidewalls 402, open top 401, and closed bottom 403. Closed bottom 403 is unitary with sidewalls 402. Sidewalls 402 are vertically oriented, are closed in section, and are provided with an upper edge 404 and a lower edge 406. In the preferred embodiment, sidewalls 402 are square in section. However, it is well within the scope of this invention to provide sidewalls 402 having sectional shapes that are polygonal or arcuate, as required by the specific application.

Bottom 403 of sagger 400 is provided with a plurality of perforations or through holes 446, and supports a fluid permeable plate 420 in a horizontal orientation thereon. Fluid permeable plate 420 is planar and has an upper surface 426, a lower surface 428 opposed to upper surface 426 and separated from it by the thickness of the plate. Fluid permeable plate 420 is identical in form and function to fluid permeable plate 520 of preferred embodiment sagger 500, and is sized to generally fill the bottom surface of sagger 400. Perforations 446 in bottom 403 are sized to allow generous heat flow upward through fluid permeable plate 420.

Sagger 400 is used in a similar fashion to sagger 500 except when material is unloaded from the sagger. To remove material from sagger 400, the sagger may be tipped and poured or vacuumed.

A third embodiment sagger 300 (FIG. 2.5, 2.6) may also be substituted for preferred embodiment sagger 500. Sagger 300 comprises sidewalls 302 that are separable from closed bottom 303. Sidewalls 302 are vertically oriented, are closed in section, and are provided with an upper edge 304 and a lower edge 306. In the preferred embodiment, sidewalls 302 are square in section. However, it is well within the scope of this invention to provide sidewalls 302 having sectional shapes that are polygonal or arcuate, as required by the specific application. An outwardly extending ledge 311 is provided on outside surface 310 of sidewall 302 adjacent upper edge 304. A downwardly extending bead 312 is provided on lower edge 306 of sidewall 302 adjacent outside surface 310.

Bottom 303 of sagger 300 consists of a fluid permeable plate 320 and a tray 341. Fluid permeable plate 320 is planar and has an upper surface 326, a lower surface 328 opposed to upper surface 326 and separated from it by the thickness of the plate. Fluid permeable plate 320 is identical in form and function to fluid permeable plate 520 of preferred embodiment sagger 500.

Tray 341 comprises an upper surface 342 and a lower surface 344 that is opposed to upper surface 342. Upper surface 342 of tray 341 is provided with a depression 348. Depression 348 has a size and shape which permits fluid permeable plate 320 to reside within depression 348 such that the fluid permeable plate 320 completely fills depression 348 and such that fluid permeable plate upper surface 326 lies flush with tray upper surface 342. Tray 341 has a plurality of perforations or through holes 346 that extend between its upper surface 342 and lower surface 344. Perforations 346 in tray 341 are sized to allow generous heat flow upward through fluid permeable plate 320.

Upper surface 342 of tray 341 is provided with a channel 350 formed along its peripheral edge. Channel 350 is sized and shaped to receive downwardly extending bead 312 of sidewall 302 therein. Lip 312 of sidewall 302 interlocks with channel 350 of tray 341 to secure tray 341 to sidewall 302 when in use.

Sagger 300 is used in a similar fashion to sagger 500 except when material is unloaded from the sagger. To remove material from sagger 300, sidewalls 302 are separated from bottom 303 by gripping ledge 313 and lifting sidewalls 302 upward. Bottom 303 is then tipped and poured and or vacuumed to remove any material thereon. When the material has been removed, sidewalls 302 are lowered until lower edge 306 rests on upper surface 342 of tray 341 and bead 312 of sidewalls 302 is received within channel 350 of tray 341.

A fourth embodiment sagger 600 (FIG. 2.8.5, 2.8.6) may also be substituted for preferred embodiment sagger 500. Sagger 600 comprises sidewalls 602, an open top 601 and bottom 603. Sidewalls 602 are vertically oriented, are closed in section, and are provided with an upper edge 604 and a lower edge 606. Lower edge 606 is provided with an inwardly extending lip 615 that extends continuously about the periphery of sidewall 602. In the preferred embodiment, sidewalls 602 are square in section. However, it is well within the scope of this invention to provide sidewalls 602 having sectional shapes that are polygonal or arcuate, as required by the specific application.

Bottom 603 of sagger 600 includes fluid permeable plate 620 and support plate 630. Fluid permeable plate 620 is planar and has an upper surface 626, a lower surface 628 opposed to upper surface 626 and separated from it by the thickness of the plate. Fluid permeable plate 620 is bounded by peripheral edge 622. Fluid permeable plate 620 is identical in form and function to fluid permeable plate 520 of preferred embodiment sagger 500, and is sized to generally fill the bottom surface of sagger 600.

Support plate 630 is provided with a plurality of perforations or through holes 646, and supports fluid permeable plate 620 in a horizontal orientation thereon adjacent the bottom of sagger 600. Support plate 630 is planar and has an upper surface 636, a lower surface 638 opposed to upper surface 636 and separated from it by the thickness of the support plate. Support plate 630 resides within sagger 600 so that the periphery of lower surface 638 of support plate 630 rests upon lip 615 of sidewalls 602. Perforations 646 in support plate 630 are sized to allow generous heat flow upward through fluid permeable plate 620.

Sagger 600 is used in a similar fashion to sagger 500 except when material is unloaded from the sagger. To remove material from sagger 600, the sagger may be tipped and poured or vacuumed.

A fifth embodiment sagger 700 (FIG. 3.0) may also be substituted for preferred embodiment sagger 500. Sagger 700 is designed to accommodate materials that contain at least some liquid. Sagger 700 comprises sidewalls 702, an open top 701 and closed bottom 703. Sidewalls 702 are vertically oriented, are closed in section, and are provided with an upper edge 704, a lower edge 706, an inside surface 708 and an outside surface 711. Inside surface 708 is provided with an outwardly extending lip 719 that extends continuously about the periphery of sidewall 702 adjacent to, but spaced apart from, closed bottom 703. In the preferred embodiment, sidewalls 702 are square in section. However, it is well within the scope of this invention to provide sidewalls 702 having sectional shapes that are polygonal or arcuate, as required by the specific application.

Fluid permeable plate 732 is planar and has an upper surface 733, a lower surface 735 opposed to upper surface 733 and separated from it by the thickness of the plate. Fluid permeable plate 732 is bounded by peripheral edge 737. Fluid permeable plate 732 is identical in form and function to fluid permeable plate 520 of preferred embodiment sagger 500, and is sized to generally fill the bottom surface of sagger 700. Fluid permeable plate 732 resides within sagger 700 so that the periphery of lower surface 735 rests upon lip 719 of sidewalls 702, providing a sump 717 for collection of liquid between fluid permeable plate 732 and closed bottom 703. Through holes 715 are formed in sidewalls 702 between lip 719 and closed bottom 703 to provide a means of draining excess liquids from sagger 700.

Sagger 700 is used in a similar fashion to sagger 500 except when material is unloaded from the sagger. To remove material from sagger 700, the sagger may be tipped and poured or vacuumed.

In the preferred embodiment, saggers 500 are paired as they move through the series of sequentially aligned heating modules 205 of furnace unit 200 such that they reside side-by-side. It is within the scope of this invention to form saggers 500 of a single, large rectangular section rather than two square-sectioned saggers positioned side by side. However, because saggers 500 are all-ceramic they are of considerable weight. This considerable weight must be considered when handling saggers, manually or automatically, in addition to the weight of the material within the sagger. Reduction in size of each individual sagger 500 and using plural saggers makes it feasible to manually handle a sagger filled with material, easier to manufacture and transport, and allows more economical replacement of damaged units.

Within each heating module 205, multiple saggers 500 are arranged to completely fill the horizontal plane that defines the furnace bed. That is, sagger pairs supported by rollers 230 extend laterally and for-and-aft so as to fill the furnace bed from wall to wall, forming movable fluid bed 228 within the heating module 205 (FIG. 2.4). Heated air enters heating module 205 beneath fluid bed 228, and is vented from the heating module above fluid bed 228, and so is therefore forced to pass up through fluid bed 228, and the material to be calcined, prior to venting.

It should be noted that this is a quiet fluid bed, rather than an agitating, turbulent fluid bed as found in prior art stationary fluid beds. That is to say, the material within sagger 500 is not disturbed by the fluid flow within the module. Hot air is forced gently upwards through the material pile within sagger 500 without disrupting the pile or causing particulate to come off the surface of the pile, resulting in relatively clean hot flue gas venting from heating module 210.

Saggers are transported within and about roller hearth furnace 100 using horizontally oriented rollers 230, 230′ (FIG. 2.4). Within high temperature heating module 210, rollers 230 are formed of all-ceramic materials so to as to withstand the high temperatures and possible caustic environment therein. Within low temperature heating module 710, cooling module 810, and outside furnace unit 200, where saggers 500 are transported between loading station 110, furnace unit 200, unloading station 120, and then returned to loading station 110, metal rollers 230′ are used. Rollers 230, 230′ form an uninterrupted, continuous surface for supporting saggers 500 throughout furnace 100 and are driven using conventional means, which includes, but is not limited to, sprocket and chain mechanisms.

As described above, furnace unit 200 is provided with four heating temperature zones including, in sequence from beginning of the calcining process to the end, drying zone 202, heating zone 204, calcining zone 206, and cooling zone 208. Each heating temperature zone is generated the appropriate individual heating module 205. Sequential heating modules 205 are positioned immediately adjacent one another so that their respective sidewalls abut. Each adjacent heating module pair are separated using a ceramic door 240, with additional ceramic doors 240 located at the inlet 201 and outlet 209 to furnace unit 200. Each door 240 is a thick ceramic plate that resides and moves within a vertical plane. When open, lower edge 246 of door 240 is positioned adjacent heating module floor 214, and upper edge 248 of door 240 resides below rollers 230. When closed, door 240 is driven up from the bottom of the furnace so that upper edge 248 of door 240 lies adjacent heater module ceiling 212. The driving mechanism employed consists of rods 244 secured using brackets 242 to each respective lateral edge 250 of door 240. Rods 244 are propelled using conventional means that may include, but are not limited to, pneumatic cylinders. Doors 240 are employed within furnace unit 200 for safety purposes and for isolating individual heating modules 210 to hold them at the required temperatures. When doors 240 are closed, very little heat escapes around them.

In use, all five furnace unit doors 240 are opened or closed simultaneously so that doors 240 are either all open, or are all closed. When all doors 240 are open, saggers 500 are advanced within furnace unit 200 to the next adjacent heating module. For example, saggers 500 that have been dried within drying zone 202 are advanced to heating zone 204. Saggers 500 that have been heated in heating zone 204 are advanced to calcining zone 206. Cooled saggers are moved out of the cooling zone 208 and transported to unloading station 120. Saggers 500 that have been calcined in calcining zone 206 are moved to cooling zone 208. Newly filled saggers are advanced into the drying module, and cooled saggers 500 are transported to the unloading station 120. After saggers 500 have been positioned within next appropriate heating module 205, all doors 240 are closed and the next heating stage ensues.

It is well within the scope of this invention to allow doors 240 to operate individually, rather than in concert. The duration of time within a respective module is dependent on the type of module and material being processed. In the illustrative example, the duration for drying zone 202 is the longest of the four heating temperature zones, and thus determines the timing of material movement within furnace unit 200.

### Indirect Heating and Heat Recovery System

Referring now to FIGS. 2.1, 2.9, and 2.10, each heating module is provided heat in the form of a hot gas, preferably hot air, at the appropriate temperature by employing an inventive indirect heating and heat recovery system 150. Indirect heating system 150 consists of an all-ceramic oxidizer 152, an all-ceramic indirect air-to-air heat exchanger 154, and one or more metal indirect, air-to-air heat exchangers 160, 166. When used herein, reference to metal heat exchangers includes heat exchangers formed of materials which may include, but are not limited to, metal, metal alloy, metals coated with thermal barriers, and hybrid (combination metal and ceramic components). Metal heat exchanger material selection is dependent upon the requirements of the specific application.

Oxidizer 152 is the heat-generating component within the system and is preferably fired using natural gas and ambient air. However it is well within the scope of this invention to use other fuels to fire oxidizer 152, as required by the specific application. These fuels may include, but are not limited to, oil, coal, and process flue gases. In the illustrative example wherein Material A is the material being calcined, oxidizer flue gas exit temperatures range from 870 to 1120 degrees Celsius.

In this system, heated air venting from both heating module 204 and calcining module 206 is directed to oxidizer 152 where it is used as a source of preheated air for use in combustion. The flue gas output from oxidizer 152 is then directed through the airside of all-ceramic heat exchanger 154 where heat energy is transferred from the airside flue gas, reducing it to a temperature in the approximate range of 560 to 760 degrees Celsius as it exits all-ceramic heat exchanger 154. The partially cooled flue gas is then directed through the airside of a first metal indirect air-to-air heat exchanger 160, where additional heat energy is transferred from the flue gas. Upon exiting first metal heat exchanger 160, the flue gas is then directed through the airside of a second metal indirect air-to-air heat exchanger 164, where additional heat energy is transferred from the flue gas. Finally, upon exiting second metal heat exchanger 160, the flue gas has an approximate temperature range of 200 to 400 degrees Celsius and is vented to stack 190.

Heat energy generated by oxidizer 152 is used to indirectly heat tube-side air within each heat exchanger 154, 160, 166, for use as the heat source in heating modules 205. Specifically, ambient air is preheated to a temperature in the approximate range of 20 to 500 degrees Celsius within the tube side of second metal heat exchanger 166 and is directed to the heat inlet duct 234 of drying module 202.

Ambient air is combined with preheated air (approximately 300 degrees Celsius) from the tube side of all-ceramic heat exchanger 154, and is then directed through the tube side of first metal heat exchanger 1.60. Heated air exiting the tube side of first metal heat exchanger 160, having a temperature in the approximate range of 300 to 600 degrees Celsius, is directed to the heat inlet duct 234 of heating module 204.

Calcining module 206 is heated via its heat inlet duct 234 using heat energy having temperatures in the approximate range of 600 to 800 degrees Celsius from the tube side of the all-ceramic heat exchanger 154. As described above, heat energy vented from the heat outlet ducts 232 of both the heating and calcining modules 204, 206 is directed back into oxidizer 152.

Ambient air is directed into the inlet duct 234 of cooling module 208 to promote efficient cooling of the post-calcined material. Cooling module 208 vents to the atmosphere.

The flow of air from the heat exchangers 154, 160, 166 is controlled so that air input to heating modules 205 is provided in a steady flow, or alternatively, may be a pulsed flow.

Method of using the Roller Hearth Calcining Furnace

The method of using the inventive roller hearth calcining furnace with movable fluid bed to calcine material A will now be described. Those skilled in the art understand that the method described herein may be used to calcine other materials, and that the method may be modified by adding or deleting heating modules 205 to furnace unit 200 so as to accommodate the calcining temperature profile of a different material. However, the underlying method of using furnace 100 remains the unchanged, regardless of material processed.

In the method described herein, clean, hot air is used as the heat source. This clean, hot air is supplied to appropriate heating modules 210, 710 from the indirect heating and heat recovery system 150, where natural gas is used to indirectly heat clean air, which is in turn used in the calcining process. Use of clean, hot air is advantageous because it allows calcining to be achieved in a clean, non-contaminating environment. It is well within the scope of this invention, however, to use alternative fluids such as natural gas or combustion flue gas as the heating fluid in heating modules 210, 710 if required by the specific application. For example, when drying sludge to recover precious metals, it is advantageous to use a starved air, low oxygen heating fluid to prevent oxidation of the metals during drying.

The method steps are as follows:

Step 1. Prior to entering furnace unit 200, saggers 500 are positioned at loading station 110. Loading station 110 is a standard solid material loading system. In the preferred embodiment, material is loaded into saggers 500 from above, using an enclosed chute to minimize dust generation. Fill a first set of saggers 500 with material to be calcined, for example material A.

Step 2. Open the plural selectively positionable doors 240, and transport the filled saggers 500 from loading station 110 into drying zone 202, and close the plural selectively positionable doors 240.

Step 3. Input heated air into drying zone 202 so that within drying zone 202 surface moisture is dried from the material to be calcined, and all material within the drying zone is heated to a uniform temperature.

Step 4. At loading station 110, fill a second set of saggers 500 with material to be calcined.

Step 5. Open the plural selectively positionable doors 240. Transport the first set of saggers 500 from drying zone 202 to heating zone 204, and transport the second set of saggers 500 from loading station 110 into drying zone 202. Close the plural selectively positionable doors 240.

Step 6. Input heated air into drying zone 202 so that so that within drying zone 202, surface moisture is dried from the material to be calcined, and all material within the drying zone is heated to a uniform temperature. Simultaneously, input heated air into heating zone 204 so that within heating zone 204 the temperature of the material to be calcined is uniformly raised to a point just below calcining temperature.

Step 7. At loading station 110, fill a third set of saggers 500 with material to be calcined.

Step 8. Open the plural selectively positionable doors 240. Transport the first set of saggers 500 from heating zone 204 to calcining zone 206, transport the second set of saggers 500 from drying zone 202 to heating zone 204, and transport the third set of saggers 500 from loading station 110 into drying zone 202. Close the plural selectively positionable doors 240.

Step 9. Input heated air into drying zone 202 so that so that within drying zone 202, surface moisture is dried from the material to be calcined, and all material within the drying zone is heated to a uniform temperature. Simultaneously, input heated air into heating zone 204 so that within heating zone 204 the temperature of the material to be calcined is uniformly raised to a point just below calcining temperature. Simultaneously, input heated air into calcining zone 206 so that within calcining zone 206 the temperature of the material to be calcined is uniformly raised to at least calcining temperature.

Step 10. At loading station 110, fill a fourth set of saggers 500 with material to be calcined.

Step 11. Open the plural selectively positionable doors 240. Transport the first set of saggers 500 from the calcining zone 206 to the cooling zone 208, the second set of saggers 500 from heating zone 204 to calcining zone 206, transport the third set of saggers 500 from drying zone 202 to heating zone 204, and transport the fourth set of saggers 500 from loading station 110 into drying zone 202. Close the plural selectively positionable doors 240.

Step 12. Input heated air into drying zone 202 so that so that within drying zone 202, surface moisture is dried from the material to be calcined, and all material within the drying zone is heated to a uniform temperature. Simultaneously, input heated air into heating zone 204 so that within heating zone 204 the temperature of the material to be calcined is uniformly raised to a point just below calcining temperature. Simultaneously, input heated air into calcining zone 206 so that within calcining zone 206 the temperature of the material to be calcined is uniformly raised to at least calcining temperature. Simultaneously input ambient air into cooling zone 208 so that within cooling zone 208 the temperature of the material to be calcined is uniformly lowered to ambient temperature.

Step 13. At loading station 110, fill a fifth set of saggers 500 with material to be calcined.

Step 14. Open the plural selectively positionable doors 240. Transport the first set of saggers 500 from cooling zone 200 to material unloading station 120, the second set of saggers 500 from the calcining zone 206 to the cooling zone 208, the third set of saggers 500 from heating zone 204 to calcining zone 206, transport the fourth set of saggers 500 from drying zone 202 to heating zone 204, and transport the fifth set of saggers 500 from loading station 110 into drying zone 202. Close the plural selectively positionable doors 240.

Step 15. Input heated air into drying zone 202 so that so that within drying zone 202, surface moisture is dried from the material to be calcined, and all material within the drying zone is heated to a uniform temperature. Simultaneously, input heated air into heating zone 204 so that within heating zone 204 the temperature of the material to be calcined is uniformly raised to a point just below calcining temperature. Simultaneously, input heated air into calcining zone 206 so that within calcining zone 206 the temperature of the material to be calcined is uniformly raised to at least calcining temperature. Simultaneously input ambient air into cooling zone 208 so that within cooling zone 208 the temperature of the material to be calcined is uniformly lowered to ambient temperature.

Step 16. At unloading station 120, remove calcined material from saggers 500. Sagger 500 and its all-ceramic fluid permeable plate 520 may be cleaned by wiping, tipping and pouring out, vacuuming, blowing air through fluid permeable ceramic plate, or a combination thereof. At loading station 110, fill a next set of saggers 500 with material to be calcined.

Step 17. Repeat steps 14-16.

Each respective set of saggers is moved through the plurality of zones at specified rate determined by the calcining temperature profile of the material being calcined, so that the calcining temperature profile of the material to be calcined is followed and so that uniform heating in each zone of the plurality of zones is achieved. In the preferred embodiment, movement of saggers through furnace 100 is fully automated. However, it may be achieved manually, or by a combination of manual and automated control.

When using sagger 500 having a drawer-style removable support plate 540, method steps 16a-16e are substituted for method step 16 above:

Step 16a. At loading station 110, fill a next set of saggers 500 with material to be calcined.

Step 16b. At unloading station 120, prepare to remove calcined material from saggers 500 by removing support plate 540 from slit 518 within sidewall 502. Support plate 540 and fluid permeable ceramic plate 520 are drawn out transversely from slit 518 so that the calcined material is generally wiped from upper surface 326 of fluid permeable plate 320 as a result of interference from sidewall 302, sidewall 302 acting as a screen and causing the calcined material to drop off support plate 540 and fluid permeable ceramic plate 520 and down through rollers 230. Preferably, calcined material is collected within a hopper that lies below rollers 230.

Step 16c. Reposition support plate 540 and fluid permeable ceramic plate 520 within sagger 500 by reinserting them into slit 518.

When using a sagger 300 having sidewalls 302 which are separable from the bottom 303, method steps 16d-16h are substituted for method step 16 above:

Step 16d. At loading station 110, fill a next set of saggers 500 with material to be calcined.

Step 16e. At unloading station 120, prepare to remove calcined material from saggers 300 by lifting the sidewalls up above the sagger bottom so that the sidewalls are spaced from the sagger bottom a distance in the range of 0.5 to 1.0 inches.

Step 16f At unloading station 120, remove calcined material from sagger 300 by drawing sagger bottom 303 out transversely from beneath the sidewalls so that the calcined material is generally wiped from upper surface 326 of fluid permeable plate 320 as a result of interference from sidewall 302, sidewall 302 acting as a screed and causing the calcined material to drop off sagger bottom 303 and down through rollers 230. Preferably, calcined material is collected within a hopper that lies below rollers 230.

Step 16g. Reposition sagger bottom 303 beneath sidewalls 302.

Step 16h. Lower sidewalls 302 onto sagger bottom 303.

What is claimed is:

1. A furnace, the furnace comprising a movable fluid bed.

2. The furnace of claim 1 wherein the furnace is heated using an indirect heating and heat recovery system.

3. The furnace of claim 2 wherein
the furnace comprises a plurality of sequential, serially aligned heating zones,
the moveable fluid bed comprises at least one all-ceramic sagger and sagger movement means, the sagger movement means both supporting any all-ceramic sagger within the furnace and allowing the sagger to selectively move through the plurality of heating zones.

4. The furnace of claim 3 wherein the at least one sagger comprises sidewalls and a plate,
the sidewalls being vertically oriented and having a closed section, the sidewalls comprising an upper edge and a lower edge,
the plate comprising a planar body formed of permeable ceramic, the plate comprising a peripheral edge, the peripheral edge surrounding the body of the plate, the plate comprising a plate upper surface and a plate lower surface which is opposed to the plate upper surface and separated from it by the thickness of the plate,
the plate residing within the sidewalls adjacent the lower edge of the sidewalls.

5. The furnace of claim 4 wherein the at least one sagger comprises an inwardly extending lip, the lip extending inwardly from the sidewalls adjacent to the lower edge of the sidewalls, wherein the plate is supported within the sidewalls by the lip.

6. The furnace of claim 5 wherein the at least one sagger comprises a support body, the support body comprising a peripheral edge and a plurality of holes therethrough, the peripheral edge of the support body abutting and confronting the lip such that the support body is supported within the sidewalls by the lip, the plate resting upon the support body in a stacked relationship within the sidewalls.

7. The furnace of claim 4 wherein the at least one sagger comprises a closed bottom, the closed bottom supporting the plate within the sagger, the closed bottom having a plurality of holes therethrough.

8. The furnace of claim 7 wherein the at least one sagger comprises a closed bottom which is unitary with the sidewalls.

9. The furnace of claim 7 wherein the at least one sagger is selectively separable into a sidewall portion and a base portion,
the base portion comprising the plate and a tray,
the tray comprising a tray upper surface and a tray lower surface, the tray lower surface being opposed to the tray upper surface, the tray further comprising a plurality of holes therethrough and extending between the tray upper surface and tray lower surface,
the tray upper surface comprising a depression formed thereon, the depression having a size and shape which permits the plate to reside within the depression such that the plate completely fills the depression and such that the plate upper surface lies flush with the tray upper surface,
the at least one sagger comprising interlocking means which allows the lower edge of the sidewall portion to interlock with the tray upper surface when the sidewall portion is not separated from the base portion.

10. The furnace of claim 9 wherein the interlocking means comprises the lower edge of the sidewall portion having a downwardly extending lip, the interlocking means further comprises the peripheral edge of the tray upper surface having a channel formed thereon, wherein the downwardly extending lip of the sidewall portion is sized and shaped to be received within the channel on the tray upper surface when in use.

11. The furnace of claim 5 wherein
at least one sagger comprises closed bottom extending between and integral with the lower edge of the sidewalls,
the inwardly extending lip is spaced apart from the bottom providing a sump between plate and the bottom,
the sidewalls comprise holes positioned between the plate and the bottom for use as a drain means.

12. The furnace of claim 4 wherein the sagger movement means comprises plural all-ceramic rollers, the plural all-ceramic rollers extending transversely to the direction of travel of the movable fluid bed through the furnace.

13. The furnace of claim 12 wherein the plurality of zones comprises a drying zone, a heating zone, a calcining zone, and a cooling zone.

14. The furnace of claim 13 wherein the plurality of zones are physically separated by providing
a first selectively positionable door between the exterior of the calcining furnace and the drying zone,
a second selectively positionable door between the drying zone and the heating zone,
a third selectively positionable door between the heating zone and the calcining zone,
a fourth selectively positionable door between the calcining zone and the cooling zone,
a fifth selectively positionable door between the cooling zone and the exterior of the calcining furnace.

15. The furnace of claim 14 wherein heat is directed into each zone beneath the fluid bed, wherein each zone is vented above the fluid bed, and wherein
heated air from both the heating zone and the calcining zone is vented to an oxidizer,
the flue gas output from the oxidizer then being directed through the air side of an all-ceramic indirect air-to-air heat exchanger,
the flue gas then exiting the all-ceramic indirect air-to-air heat exchanger and being directed through the air side of at least one metal indirect air-to-air heat exchanger, the flue gas exiting the at least one metal indirect air-to-air heat exchanger and venting to the stack,
wherein ambient air is preheated within the tube side of the at least one metal indirect air-to-air heat exchanger,
the preheated air exiting the at least one metal indirect air-to-air heat exchanger and being split into a first preheated portion and a second preheated portion such that the first preheated portion is directed to the drying zone and used as the heat source for the drying zone, the second preheated portion is directed to the tube side of the all-ceramic indirect air-to-air heat exchanger where it is indirectly heated by the oxidizer flue gas so that the preheated air becomes hot air,
ambient air is heated to hot air within the tube side of the all ceramic heat exchanger, the hot air exiting the tube side of the all-ceramic indirect air-to-air heat exchanger and being directed to the calcining zone and used as the heat source for the calcining zone.

16. The furnace of claim 15 wherein the at least one metal indirect air-to-air heat exchanger comprises a first metal indirect air-to-air heat exchanger and a second metal indirect air-to-air heat exchanger, wherein
the flue gas exiting the all-ceramic indirect air-to-air heat exchanger is directed through the air side of the first metal indirect air-to-air heat exchanger, the flue gas exiting the air side of the first metal indirect air-to-air heat exchanger and then being directed through the air side of the second metal indirect air-to-air heat exchanger, the flue gas exiting the air side of the second metal indirect air-to-air heat exchanger and venting to the stack,
ambient air is preheated within the tube side of both the first and second metal indirect air-to-air heat exchangers,
the preheated air exiting the tube side of the second metal indirect air-to-air heat exchanger and being directed to the drying zone and used as the heat source for the drying zone,
the preheated air exiting the tube side of the first metal indirect air-to-air heat exchanger and being directed to the heating zone and used as the heat source for the heating zone.

17. The furnace of claim 16 wherein
the at least one sagger comprises 32 saggers,
the sidewalls of each sagger comprise a square closed section so as to have 4 sides,
the 32 saggers being paired such that a first sagger resides adjacent a second sagger so that the confronting sides abut each other, and such that 16 sagger pairs are provided,
each zone of the plurality of zones comprises four sagger pairs, the four sagger pairs arranged in close serial alignment within the zone such that a first pair abuts a second pair, the second pair abuts the first pair on a first side and a third pair on the opposing side, the third pair abut the second pair on a first side and a fourth pair on the opposing side, and the fourth pair abuts the third pair,
each zone comprising a first lateral side wall, a second lateral side wall opposed to the first lateral side wall and separated from it by the plural rollers, an inlet door, and an outlet door opposed to the inlet door and separated from it by the respective first and second lateral side walls, wherein
each zone is sized such that when four sagger pairs reside within the zone, the sides of the sagger pairs abut the respective confronting first lateral side wall, second lateral side wall, inlet door, and outlet door of the zone,
so that when heat is directed into the zone below the fluid bed, the heat must pass through a sagger prior to venting.

18. An all-ceramic sagger for use in a roller hearth furnace, the sagger comprising side walls, the sidewalls having an upper edge and a lower edge,
the sagger comprising a sagger bottom adjacent the lower edge of the sidewalls,
the sagger bottom comprising a permeable ceramic plate to allow uniform flow of air through the sagger.

19. The all ceramic sagger of claim 18 wherein
the sidewalls are selectively separable from the sagger bottom
the lower edge of the sidewalls is provided with an downwardly extending bead,
the permeable ceramic plate comprises an upper surface, a lower surface opposed the upper surface and separated from it by the thickness of the permeable ceramic plate, and a peripheral edge, wherein
the sagger bottom comprising a tray which supports the permeable ceramic plate, the tray comprising a channel formed upon the upper surface of the tray which is sized and shaped to receive the downwardly extending bead of the sidewalls.

20. The all ceramic sagger of claim 19 wherein
the tray comprising an upper surface, a lower surface opposed to the upper surface and separated from it by the thickness of the tray, and perforations extending from the upper surface to the lower surface
the tray comprising a vacancy formed on the upper surface thereof, the vacancy sized and shaped to receive the permeable ceramic plate therewithin such that the upper surface of the permeable ceramic plate lies flush with the upper surface of the tray.

21. The all ceramic sagger of claim 20 wherein the exterior surface of the sidewalls comprises an outwardly extending ledge adjacent the upper edge of the sidewalls for use in grasping the sidewalls when separating the sidewalls from the sagger bottom.

22. The all ceramic sagger of claim 18 wherein the lower edge of the sidewalls comprises an inwardly extending lip, the permeable ceramic plate being supported within the sidewalls by the inwardly extending lip.

23. The all ceramic sagger of claim 22 wherein the sagger bottom comprises a planar support body, the planar support body comprising a peripheral edge and plural perforations therethrough, the peripheral edge of the planar support body resting on and supported by the inwardly extending lip, the permeable ceramic plate residing on an upper surface of the planar support body such that the permeable ceramic plate lies in a stacked relationship with the planar support body.

24. The all ceramic sagger of claim 23 wherein the sidewalls comprise a slit positioned adjacent the lower edge of the sidewall, and wherein the planar support body and permeable ceramic plate may be withdrawn from the sagger through the slit.

25. The all ceramic sagger of claim 18 wherein the sidewalls and the sagger bottom are unitary and monolithic, the sagger bottom comprises a plurality of through holes between the interior and exterior of the sagger, the permeable ceramic plate is supported within the sagger by the sagger bottom such that it overlies and rests on the sagger bottom.

26. The all ceramic sagger of claim 18 wherein the sagger bottom comprises a sump formed below the permeable ceramic plate, the permeable ceramic plate maintained in a position overlying the sump.

27. The all ceramic sagger of claim 26 wherein the sump comprises a closed bottom surface which is integral with sidewalls, the sidewalls comprising a plurality of drain holes, the drain holes positioned between the permeable ceramic plate and the closed bottom surface.

28. A method of calcining using a roller hearth furnace with a moveable fluid bed,
the roller hearth furnace comprising a furnace box, an oxidizer, an all-ceramic indirect air-to-air heat exchanger, a first metal indirect air-to-air heat exchanger and a second metal indirect air-to-air heat exchanger,
the furnace box comprising an elongate housing physically divided by plural selectively positionable doors into a plurality of zones,
the furnace box comprising a ceiling, a floor opposed to the ceiling, a first lateral side, a second lateral side opposed to the first lateral side, a horizontal transverse axis which extends between the first lateral side and the second lateral side, and a horizontal longitudinal axis which extends perpendicularly to the transverse axis,
the furnace box comprising plural all-ceramic rollers extending through the furnace box in parallel with the transverse axis,
the roller hearth furnace comprising a plurality of saggers, each sagger comprising sagger sidewalls, an open top, and a sagger bottom, the sagger bottom comprising a permeable ceramic diffusion plate, the plurality of saggers arranged in a planar array upon the rollers within the furnace box to form the movable fluid bed, wherein
the plurality of zones comprising, in sequence, a drying zone, a heating zone, a calcining zone, and a cooling zone, wherein
heat is directed into each zone beneath the fluid bed, and the heat within each zone is vented out of the zone through the ceiling above the fluid bed so that heat passes upwards through the fluid bed and so that the material to be calcined is uniformly heated,
vented hot air from both the heating zone and the calcining zone is vented to the oxidizer,
the flue gas output from the oxidizer then being directed through the air side of the all-ceramic indirect air-to-air heat exchanger,
the flue gas exiting the all-ceramic indirect air-to-air heat exchanger is directed through the air side of the first metal indirect air-to-air heat exchanger, the flue gas exiting the air side of the first metal indirect air-to-air heat exchanger and then being directed through the air side of the second metal indirect air-to-air heat exchanger, the flue gas exiting the air side of the second metal indirect air-to-air heat exchanger and venting to the stack,
ambient air is preheated within the tube side of both the first and second metal indirect air-to-air heat exchangers,
the preheated air exiting the tube side of the second metal indirect air-to-air heat exchanger and being directed to the drying zone and used as the heat source for the drying zone,
the preheated air exiting the tube side of the first metal indirect air-to-air heat exchanger and being directed to the heating zone and used as the heat source for the heating zone,
ambient air is heated to hot air within the tube side of the all ceramic heat exchange, the hot air exiting the tube side of the all-ceramic indirect air-to-air heat exchanger and being directed to the calcining zone and used as the heat source for the calcining zone,
the method of calcining including the following steps:
Step 1. fill a first subset of the plurality of saggers with material to be calcined,
Step 2. open the plural selectively positionable doors, place the first subset of the plurality of saggers within the drying zone, and close the plural selectively positionable doors, so that within the drying zone surface moisture is dried from the material to be calcined, and all material within the drying zone is heated to a uniform temperature,
Step 3. fill a second subset of the plurality of saggers with material to be calcined,
Step 4. open the plural selectively positionable doors, place the first subset of the plurality of saggers within the heating zone, place the second subset of the plurality of saggers within the drying zone, and close the plural selectively positionable doors, so that within the heating zone, the temperature of the material to be calcined is raised to a point just below calcining temperature and so that while the material within the first subset of the plurality of saggers is heated within the heating zone, the material within the second subset of the plurality of saggers is dried within the drying zone,
Step 5. fill a third subset of the plurality of saggers with material to be calcined,
Step 6. open the plural selectively positionable doors, place the first subset of the plurality of saggers within the calcining zone, place the second subset of the plurality of saggers within the heating zone, place the third subset of the plurality of saggers within the drying zone, and close the plural selectively positionable doors so that within the calcining zone, the material to be calcined is heated to a temperature wherein the chemically bound water within the material is driven off the material resulting in a calcined material, and so that while the material within the first subset of the plurality of saggers is calcined within the calcining zone, the material within the second subset of the plurality of saggers is heated within the heating zone, and the material within the third subset of the plurality of saggers is dried within the drying zone,
Step 7. fill a fourth subset of the plurality of saggers with material to be calcined,
Step 8. open the plural selectively positionable doors, place the first subset of the plurality of saggers within the cooling zone, place the second subset of the plurality of saggers within the calcining zone, place the third subset of the plurality of saggers within the heating zone, place the fourth subset of the plurality of saggers within the drying zone, and close the plural selectively positionable doors so that within the cooling zone, the calcined material cooled to ambient temperature and so that while the material within the first subset of the plurality of saggers is cooled within the cooling zone, the material within the second subset of the plurality of saggers is calcined within the calcining zone, the material within the third subset of the plurality of saggers is heated within the heating zone, and the material within the fourth subset of the plurality of saggers is dried within the drying zone,
Step 9. open the plural selectively positionable doors, remove the first subset of the plurality of saggers from the furnace box, place the second subset of the plurality of saggers within the cooling zone, place the third subset of the plurality of saggers within the calcining zone, place the fourth subset of the plurality of saggers within the heating zone, and close the plural selectively positionable doors,
Step 10. remove the calcined material from the first subset of the plurality of saggers,
Step 11. open the plural selectively positionable doors, remove the second subset of the plurality of saggers from the furnace box, place the third subset of the plurality of saggers within the cooling zone, place the fourth subset of the plurality of saggers within the calcining zone, and close the plural selectively positionable doors,
Step 12. remove the calcined material from the second subset of the plurality of saggers,
Step 13. open the plural selectively positionable doors, remove the third subset of the plurality of saggers from the furnace box, place the fourth subset of the plurality of saggers within the cooling zone, and close the plural selectively positionable doors,
Step 14. remove the calcined material from the third subset of the plurality of saggers,
Step 15. open the plural selectively positionable doors, remove the fourth subset of the plurality of saggers from the furnace box, and close the plural selectively positionable doors,
Step 16. remove the calcined material from the fourth subset of the plurality of saggers.

29. The method of calcining of claim 28 wherein each respective subset of the plurality of saggers is moved through the plurality of zones at specified rate determined by the calcining temperature profile of the material being calcined, so that the calcining temperature profile of the material to be calcined is followed and so that uniform heating in each zone of the plurality of zones is achieved.

30. The method of calcining of claim 29 wherein the calcined material is removed from each respective subset of the plurality of saggers by using a vacuum.

31. The method of calcining of claim 29 wherein each sagger comprises sidewalls which are separable from the sagger bottom, and wherein the calcined material is removed from each respective subset of the plurality of saggers using the following method steps:
Step 1. lift the sidewalls up above the sagger bottom so that the sidewalls are spaced from the sagger bottom a distance in the range of 0.5 to 1.0 inches,
Step 2. draw the sagger bottom out transversely from beneath the sidewalls so that the calcined material is generally prevented from being drawn out concurrent with the sagger bottom due to interference from the sidewall, the sidewall acting as a screen and causing the calcined material to drop off the sagger bottom and down through the rollers,
Step 3. collect the calcined material within a hopper which lies below the rollers,
Step 4. reposition the sagger bottom beneath the sidewalls,
Step 5. lower the sidewalls onto the sagger bottom.

32. The method of calcining of claim 29 wherein the sagger comprises a removable tray bottom, the removable tray bottom supporting the permeable ceramic diffusion plate within the sagger bottom, sagger sidewalls comprising a slit adjacent the sagger bottom, the removable tray bottom being removable from the sagger by sliding the removeable tray bottom through the slit.

33. The method of calcining of claim 29 wherein all method steps are fully automated.

34. A roller hearth furnace with a moveable permeable ceramic fluid bed,
the roller hearth furnace comprising an indirect heating system and a furnace box,
the indirect heating system comprising an oxidizer, an all-ceramic indirect air-to-air heat exchanger, and at least one metal indirect air-to-air heat exchanger,
the furnace box comprising an elongate housing physically divided by plural selectively positionable doors into a plurality of sequential, serially-aligned zones,
the furnace box comprising a ceiling, a floor opposed to the ceiling, a first lateral side, a second lateral side opposed to the first lateral side, a horizontal transverse axis which extends between the first lateral side and the second lateral side, and a horizontal longitudinal axis which extends perpendicularly to the transverse axis,
the furnace box comprising plural all-ceramic rollers extending through the furnace box in parallel with the transverse axis,
the roller hearth furnace comprising a plurality of saggers, the saggers comprising sagger sidewalls, an open top, and a closed sagger bottom, the sagger bottom comprising a permeable ceramic diffusion plate, the plurality of saggers arranged in a planar array and supported upon the rollers within the furnace box forming a permeable ceramic fluid bed which is movable through the plurality of sequential, serially aligned zones of the furnace box.

35. The roller hearth furnace of claim 34 wherein the plurality of zones comprises, in serially aligned sequence, a drying zone, a heating zone, a calcining zone, and a cooling zone, wherein
heat from the indirect heating system is directed into each zone beneath the fluid bed,
each zone is vented through the ceiling of the zone above the fluid bed,
heated air from both the heating zone and the calcining zone is vented to the oxidizer,
the flue gas output from the oxidizer then being directed through the air side of the all-ceramic indirect air-to-air heat exchanger,
the flue gas then exiting the all-ceramic indirect air-to-air heat exchanger and being directed through the air side of the at least one metal indirect air-to-air heat exchanger, the flue gas exiting the at least one metal indirect air-to-air heat exchanger and venting to the stack,
wherein ambient air is preheated within the tube side of the at least one metal indirect air-to-air heat exchanger,
the preheated air exiting the at least one metal indirect air-to-air heat exchanger and being split into a first preheated portion and a second preheated portion such that the first preheated portion is directed to the drying zone and used as the heat source for the drying zone, the second preheated portion is directed to the tube side of the all-ceramic indirect air-to-air heat exchanger where it is indirectly heated by the oxidizer flue gas so that the preheated air becomes hot air,
the hot air exiting the tube side of the all-ceramic indirect air-to-air heat exchanger and being directed to the calcining zone and used as the heat source for the calcining zone.

36. The calcining furnace of claim 35 wherein the at least one metal indirect air-to-air heat exchanger comprises a first metal indirect air-to-air heat exchanger and a second metal indirect air-to-air heat exchanger, wherein
the flue gas exiting the all-ceramic indirect air-to-air heat exchanger is directed through the air side of the first metal indirect air-to-air heat exchanger, the flue gas exiting the air side of the first metal indirect air-to-air heat exchanger and then being directed through the air side of the second metal indirect air-to-air heat exchanger, the flue gas exiting the air side of the second metal indirect air-to-air heat exchanger and venting to the stack,
ambient air is preheated within the tube side of both the first and second metal indirect air-to-air heat exchangers,
the preheated air exiting the tube side of the second metal indirect air-to-air heat exchanger and being directed to the drying zone and used as the heat source for the drying zone,
the preheated air exiting the tube side of the first metal indirect air-to-air heat exchanger and being directed to the heating zone and used as the heat source for the heating zone.

37. The roller hearth furnace of claim 36 wherein the permeable ceramic fluid bed is caused to move along the longitudinal axis of the furnace box using roller movement means, wherein roller movement means selectively causes each roller to rotate, and wherein the rotation of the rollers causes the planar array of saggers to move along the longitudinal axis of the furnace box.

38. The roller hearth furnace of claim 37 wherein each of the doors comprises an all-ceramic plate, attachment means, and door movement means, wherein
the all-ceramic plate comprises a planar body bounded by a peripheral edge, the peripheral edge comprising a top edge, a bottom edge opposed to the top edge, a first lateral side edge, and a second lateral side edge opposed to the first lateral side edge,
attachment means is fixed to each respective first lateral and second lateral side edge for securement of the door to the door movement means,
door movement means allowing translational movement of the door within the plane of the planar body.

39. The roller hearth furnace of claim 37 wherein the door movement means provides movement of each door between a first open position and a second closed position, wherein in the first open position, the top edge of the all ceramic plate lies below the fluid bed and the bottom edge lies adjacent to the floor of the furnace box, and wherein in the second closed position the top edge of the all ceramic plate lies adjacent the ceiling of the furnace box, and the bottom edge lies below, and in vertical alignment with the top edge.

40. A movable fluid bed furnace, the movable fluid bed furnace comprising at least one heating module and an indirect heating system,
the indirect heating system comprising an oxidizer, an all-ceramic indirect air-to-air heat exchanger, and at least one metal indirect air-to-air heat exchanger,
the at least one heating module comprising a ceiling, a floor opposed to the ceiling, a first lateral side, a second lateral side opposed to the first lateral side, a horizontal transverse axis which extends between the first lateral side and the second lateral side, and a horizontal longitudinal axis which extends perpendicularly to the transverse axis, the at least one heating module comprising an inlet side and an outlet side opposed to the inlet side, the inlet and outlet sides extending between each respective first and second lateral sides,
the at least one heating module comprising a movable fluid bed.

41. The movable fluid bed furnace of claim 40 wherein the movable fluid bed comprises at least one sagger and sagger movement means,
the at least one sagger supported within and transported through the at least one heating module using the sagger movement means,
the at least one sagger comprising sidewalls having a closed cross section, the at least one sagger comprising an open top, and a sagger bottom, the sagger bottom comprising a permeable ceramic plate.

42. The movable fluid bed furnace of claim 41 wherein the sagger movement means comprises a plurality of rollers and roller activation means,
the plurality of rollers extending between the first lateral side and the second lateral side of the at least one heating module so as to form a rolling plane for moving the at least one sagger in parallel with the longitudinal axis.

43. The moveable fluid bed furnace of claim 42 wherein the at least one heating module comprises an open interior space, the open interior space surrounding the movable fluid bed,
the at least one heating module comprises a plenum formed therein below the open interior space, the plenum separated from the open interior space by a diffusion plate, the diffusion plate lying parallel to and below the movable fluid bed, the diffusion plate provided with a plurality of holes, the holes placed to direct fluid from the plenum into the at least one sagger,
the at least one heating module comprising a fluid inlet duct in the first lateral side, the fluid inlet duct intersecting the at least one heating module between the diffusion plate and the floor so as to provide a fluid to the plenum,
the at least one heating module comprising a fluid outlet duct in the ceiling so as to allow venting of the fluid from the at least one heating module.

44. The moveable fluid bed furnace of claim 43 wherein the at least one heating module comprises at a first heating module and a second heating module, the first heating module and the second heating module are positioned immediately adjacent each other such that the sagger movement means is uninterrupted between the first heating module and the second heating module, and such that the outlet side of the first heating module abuts the inlet side of the second heating module,
the first heating module comprising an all-ceramic diffusion plate, and all-ceramic rollers, the all-ceramic rollers supported within each respective first lateral side and second lateral side of the at least one heating module using an elongate sleeve,
the sleeve residing in a through hole formed in within each respective first lateral side and second lateral side of the first heating module such that the sleeve protrudes into the interior space of the first heating module, the protruding portion of the sleeve providing a guide for the at least one sagger within the first heating module,
the second heating module comprising a metal diffusion plate and metal rollers, the metal rollers comprising a guide bushing, the guide bushing encircling the metal roller and positioned adjacent each respective first and second lateral side, the guide bushing providing a guide for the at least one sagger within the second heating module.

45. The moveable fluid bed furnace of claim 44 wherein the inlet side of the first heating module comprises a first door, the outlet side of the first heating module comprises a second door, and the outlet side of the second heating module comprises a third door, wherein
the second door provides a means of selectively separating the first heating module from the second heating module such that
when the second door is open, the at least one sagger may be transported along the rolling plane from the first heating module to the second heating module,
when the second door is closed, the at least one sagger is prevented from being transported along the rolling plane from the first heating module to the second heating module, and
when the first, second, and third doors are closed, the first heating module is thermally isolated from the second heating module.
